(19) United States
(12) Patent Application Publication
(10) Pub. No.: US 2012/0073693 A1
(43) Pub. Date: Mar. 29, 2012

(54) INSULATION AND METHODS OF INSULATING

(75) Inventors: Robert P. Collier, Gahanna, OH (US); Brian Patrick O'Riordan, Ashville, OH (US); George A. Bowne, Columbus, OH (US)

(73) Assignee: Owens Corning Intellectual Capital, LLC, Toledo, OH (US)

(21) Appl. No.: 13/274,660

(22) Filed: Oct. 17, 2011

Related U.S. Application Data
(63) Continuation-in-part of application No. 13/149,144, filed on May 31, 2011.
(60) Provisional application No. 61/466,165, filed on Mar. 22, 2011.

(51) Int. Cl. F16L 55/00; F16L 59/14; F16L 59/02; B23P 19/00; B32B 3/06

(52) U.S. Cl. 138/103; 29/428; 428/74

(57) ABSTRACT

An insulation panel and a method of insulating a pipeline are disclosed by the present application. In one exemplary embodiment, the insulation panel includes one or more pieces of compressible fiberglass insulation material and a coated fabric cover encasing the one or more pieces of insulation material. The coated fabric cover includes a first fastening portion disposed along a first end of the insulation panel and a second fastening portion disposed between the first end and a second end of the insulation panel. The first end of the insulation panel overlaps the second end of the insulation panel when the insulation panel is installed on a pipeline or other structure. Further, attachment of the first fastening portion to the second fastening portion secures the coated fabric cover around the pipeline or other structure.

### CROSS REFERENCE TO RELATED APPLICATIONS

This application is a continuation in part of U.S. patent application Ser. No. 13/149,144, filed on May 31, 2011 and titled “Insulation and Methods of Insulating”, which claims priority to U.S. Provisional Patent Application No. 61/466,165, filed on Mar. 22, 2011 and titled “Insulation and Methods of Insulating”, both of which are hereby incorporated by reference in their entirety.

### BACKGROUND

Pipelines and other similar structures transport fluids and other materials, such as oil, water, and sewage, over long distances and through various medium, e.g., above ground, below ground, underwater, through marshes, etc. Pipelines are typically exposed to all types of climates, weather, and temperatures. For example, some pipelines may be exposed to extreme climates in which the temperature may reach −65 degrees Fahrenheit or lower. In order to control heat loss from the materials carried within structures such as pipelines, the structures may be insulated.

### SUMMARY

An insulation panel, a method of installing an insulation panel, a method of insulating a pipeline, a method of adding insulation to a pipeline, a method of making an insulation panel, and a pipeline are disclosed by the present application.

For example, in one exemplary embodiment, an insulation panel comprises one or more pieces of compressible fiberglass insulation material and a coated fabric cover encasing the one or more pieces of insulation material. The coated fabric cover comprises a first fastening portion disposed along a first end of the insulation panel and a second fastening portion disposed between the first end and a second end of the insulation panel. The first end of the insulation panel overlaps the second end of the insulation panel when the insulation panel is installed on a pipeline or other structure. Further, attachment of the first fastening portion to the second fastening portion secures the coated fabric cover around the pipeline or other structure.

In another exemplary embodiment, a method of insulating a pipeline is disclosed. An insulation panel is delivered to the pipeline. One or more elongated flexible members are attached to the first fastening portion of the insulation panel. The one or more elongated flexible members are tossed over the top of the pipeline and are used to pull the insulation panel over the top of the pipeline such that the insulation panel is draped over the pipeline. The first end of the insulation panel is overlapped with the second end of the insulation panel. The first fastening portion is attached to the second fastening portion to secure the coated fabric cover of the insulation panel around the pipeline.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to example the principles of the inventions.

FIGS. 1A and 1B illustrate top and side views, respectively, of an insulation panel according to an embodiment of the present application.

FIGS. 2A and 2B illustrate side and end views, respectively, of an embodiment of an insulation panel installed on a pipeline.

FIGS. 3A-3G illustrate top views of various embodiments of an insulation panel.

FIGS. 4A-4C illustrate top views of various embodiments of an insulation panel.

FIG. 4D illustrates an end view of an embodiment of an insulation panel installed on a pipeline component.

FIG. 5 illustrates a top view of another embodiment of an insulation panel.

FIGS. 6A-6B illustrate end and side views, respectively, of another embodiment of an insulation panel installed on a pipeline.

FIG. 7A illustrates a top view of another embodiment of an insulation panel.

FIGS. 7B-7C illustrate side and end views, respectively, of the insulation panel of FIG. 7A installed on a pipeline.

FIG. 8A illustrates a top view of yet another embodiment of an insulation panel.

FIG. 8B illustrates a side view of the insulation panel of FIG. 8A installed on a pipeline.

FIG. 9 illustrates a side view of an embodiment of two insulation panels installed on a pipeline.

FIG. 10 illustrates a side view of another embodiment of two insulation panels installed on a pipeline.

FIGS. 11A-11F illustrate end views and top views of an embodiment of an insulation panel being installed on a pipeline.

FIG. 12A illustrates a perspective view of an embodiment of a plurality of insulation panels installed on a pipeline.

FIG. 12B illustrates a perspective view of the insulation panels of FIG. 12A installed on a pipeline and covered by an embodiment of an overwrap.

FIG. 13 illustrates a top view of another embodiment of an insulation panel installed on a pipeline.

FIG. 14 illustrates an end view of an embodiment of an insulation panel installed on a pipeline having an existing insulation system.

FIGS. 15A-15C illustrate top, side, and end views, respectively, of another embodiment of an insulation panel.

FIGS. 16A and 16B illustrate side and end views, respectively, of the insulation panel of FIGS. 15A-15C installed on a pipeline having an existing insulation system.

FIG. 17A illustrates a cross sectional end view of an embodiment of an insulation panel having a plurality of insulation layers.

FIG. 17B illustrates a cross sectional end view of the insulation panel of FIG. 17A installed on a pipeline.

FIG. 18A illustrates a side view of an embodiment of a plurality of insulation panels installed on a pipeline.

FIG. 18B illustrates a side view of the insulation panels of FIG. 18A installed on a pipeline and covered by another embodiment of an overwrap.

FIGS. 19A-19C illustrate methods of installing an insulation panel according to embodiments of the present application.

FIGS. 20A and 20B illustrate cross sectional end views of an embodiment of an insulation panel in a compressed configuration and an expanded configuration, respectively.

FIGS. 21A-21D illustrate end views of an embodiment of an insulation panel being installed on a pipeline.

FIGS. 22A-22C illustrate cross sectional end views of an insulation panel being manufactured according to an embodiment of the present application.

FIGS. 23A-23C illustrate cross sectional end views of an insulation panel being manufactured according to another embodiment of the present application.

FIGS. 24A-24B illustrate top views, FIGS. 24C-24D illustrate side views, and FIGS. 24E-24F illustrate cross sectional end views of an insulation panel being manufactured according to yet another embodiment of the present application.

FIGS. 25A and 25B illustrate top and cross sectional end views, respectively, of an embodiment of a web of cover material.

FIGS. 26A and 26B illustrate top and cross sectional end views, respectively, of a plurality of insulation panels being manufactured according to an embodiment of the present application.

FIGS. 27A and 27B illustrate top and cross sectional end views, respectively, of an insulation panel of FIGS. 26A and 26B.

FIG. 28A illustrates a cross sectional end view of an embodiment of an insulation panel.

FIG. 28B illustrates a cross sectional end view of the insulation panel of FIG. 28A installed on a pipeline.

FIGS. 29A and 29B illustrate top and cross sectional end views, respectively, of an embodiment of an insulation.

### DESCRIPTION OF EMBODIMENTS

As described herein, when one or more components are described as being connected, joined, affixed, coupled, attached, or otherwise interconnected, such interconnection may be direct as between the components or may be in direct such as through the use of one or more intermediary components. Also as described herein, reference to a “member,” “component,” or “portion” shall not be limited to a single structural member, component, or element but can include an assembly of components, members or elements.

Insulation and methods of insulating an object are disclosed in the present application. In many exemplary embodiments disclosed herein, insulation panels are described as being used to insulate a pipeline. The pipeline may or may not include an existing insulation system, such as, for example, insulation material that surrounds the pipe of the pipeline and is encased in a hard outer shell. However, the insulation panels of the present application may be used to insulate any pipe, tube, duct, and/or conduit and are not limited to only pipelines. The insulation panels may also be used to insulate a variety of other objects, such as tanks, vessels, trailers, or railroad cars. The insulation panels of the present application may include thermal and/or acoustical insulation.

The insulation panels may be configured for use in cold weather climates and inclement weather conditions. For example, the insulation panels may be flexible at low temperatures (e.g., −65 degrees F.) such that the panels may be wrapped around a pipeline in cold weather regions. The insulation panels may also be made from a tough, durable, weatherproof material to prohibit damage to the panel from various weather conditions, such as high winds, rain, snow, and ice. As such, the insulation panels may be water resistant and capable of being secured to a pipeline or other object in such a way as to prohibit removal or damage from environmental elements. The insulation panels may also be resistant to ultraviolet light (UV) or sunlight to prohibit degradation of the panel over a period of time (e.g., 10-20 years or longer).

The insulation panels may also be configured to withstand impacts and prohibit damage to the panel from potential hazards, such as animals, vehicles, or humans. The insulation panels may be configured to prohibit tampering, theft, or sabotage of the panel. Further, the insulation panels may be compressible and lightweight to facilitate transportation and installation of the panel on pipelines or other objects in remote regions of the world. The insulation panels may also be capable of being easily repaired if damaged.

The insulation panels may also be configured to be easily removed from a pipeline or other structure, such as, for example, to permit maintenance or repair of the insulation panel or the pipeline. For example, fluid in the pipeline may freeze or the pipeline may break necessitating removal of the insulation panel such that the section of the pipeline may be heated, thawed, or otherwise fixed.

An insulation panel generally includes a cover or jacket encasing an insulation material. The cover provides structure to the insulation panel and protects the insulation material from the elements and other potential hazards. The cover is also configured to facilitate installation of the insulation panel on a pipeline or other similar structure.

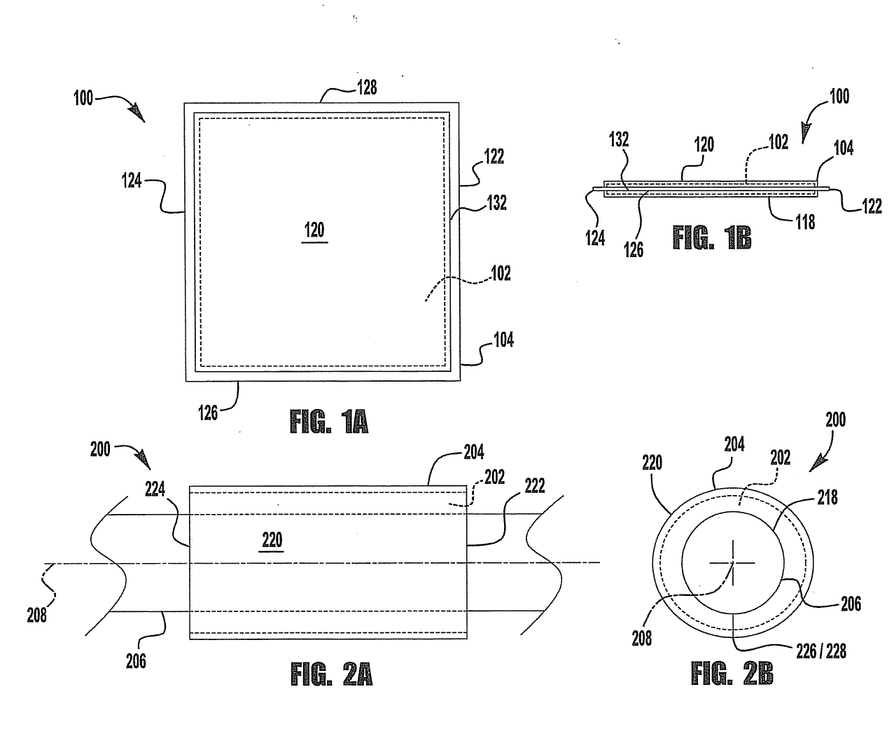

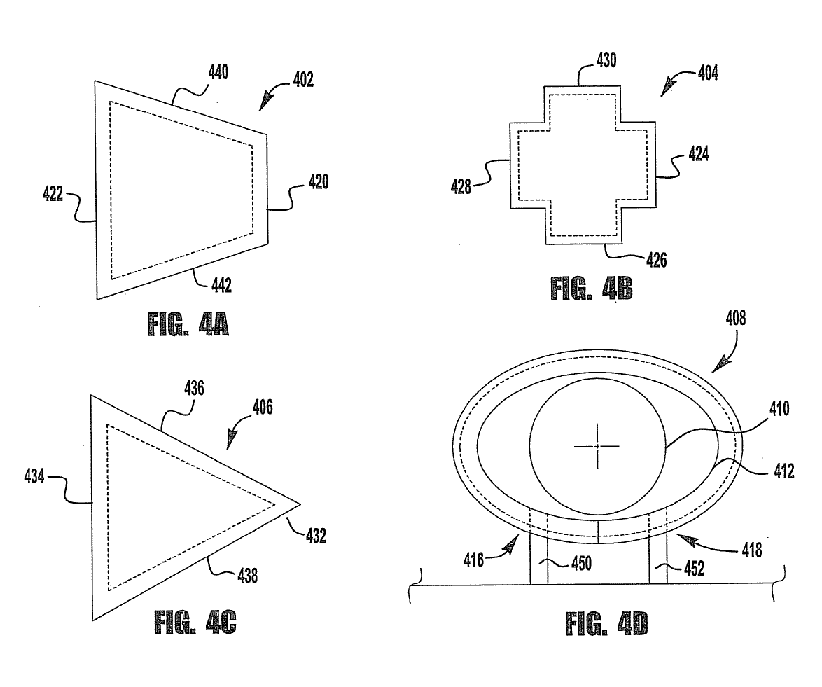

FIGS. 1A and 1B illustrate an insulation panel 100 according to one embodiment. The insulation panel 100 comprises a cover 104 and an insulation material 102. As shown, the insulation material 102 is encased within the cover 104 to form a blanket like structure. The cover 104 may fit tightly or loosely around the insulation material 102. As shown, the insulation panel 100 is rectangular in shape and has a top surface 120, a bottom surface 118 (see FIG. 1B), a first side 122, a second side 124, a third side 126, and a fourth side 128. However, the insulation panel 100 may be a variety of shapes, e.g., circular, square, oval, trapezoidal (see FIG. 4A), cross-shaped (see FIG. 4B), triangular (see FIG. 4C), or other shape, and have more or less surfaces and/or sides.

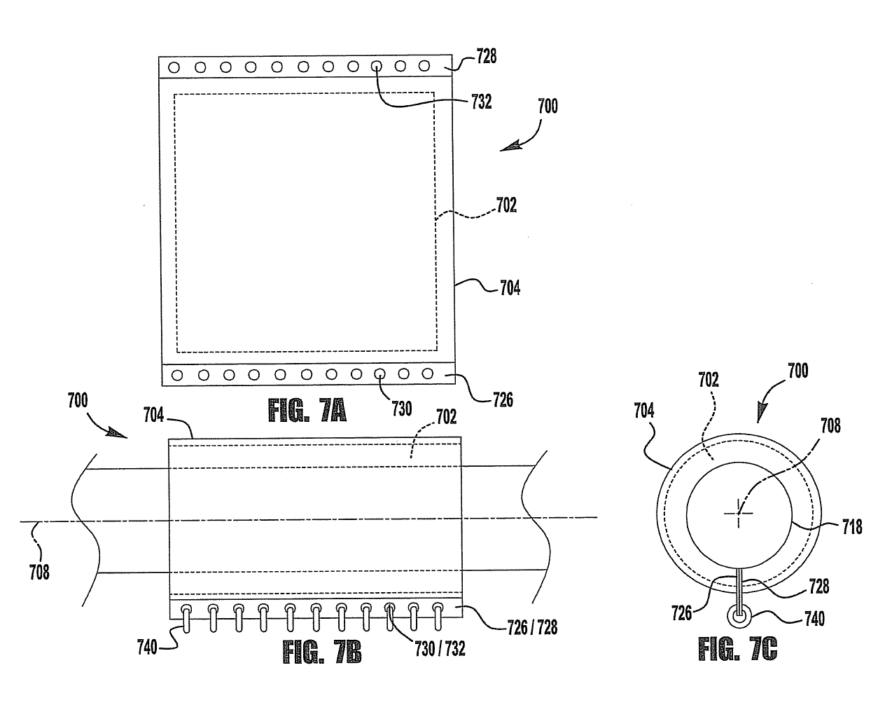

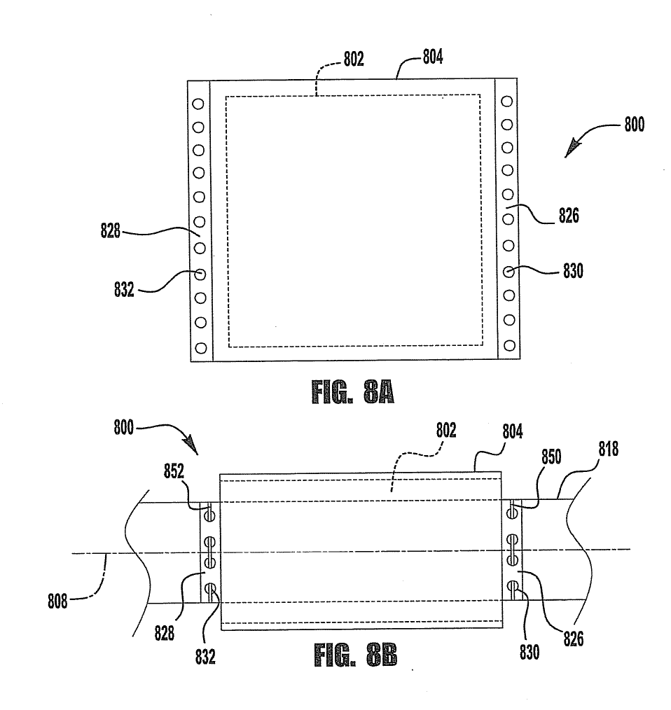

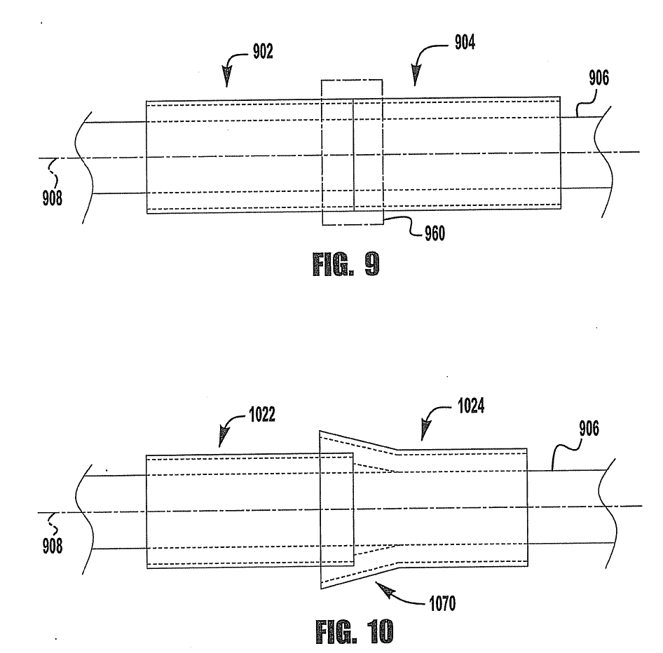

The cover of the insulation panel of the present application may include an outer portion for fastening the insulation panel to a pipeline or other structure. As illustrated in FIGS. 1A and 1B, the cover 104 of the insulation panel 100 includes a flat, outer portion 132 around the insulation material 102. The outer portion 132 extends along all four sides of the insulation panel 100. As illustrated in FIG. 1B, the outer portion 132 also extends from a middle portion of the sides of the insulation panel 100. The outer portion 132 may be used as a fastening area to secure the insulation panel 100 to the pipeline or other structure. For example, as discussed below and shown in FIGS. 7A-8B, the outer portion of the insulation panel may include openings configured for receipt of a fastener or other like means to secure the insulation panel to a pipeline or other structure. The openings may be reinforced, e.g., with grommets.

In some embodiments, the insulation panel may or may not include a cover having an outer portion. Further, the outer portion of the cover may extend along less than all the sides of the insulation panel, e.g., only along two opposing sides of the insulation panel or only along one side of the panel. One or more sections of the outer portion may be larger than other sections of the outer portion, e.g., the outer portion may be wider in some sections than others. Further, one or more outer portions may extend only partially along a side of the insulation panel, e.g., one or more flaps may extend from a side of the insulation panel. The outer portion may also extend from a side of the insulation panel at the top, bottom, or anywhere in between. The outer portion may be any thickness, e.g., the thickness of the outer portion may be more or less than the thickness of the insulation material.

The cover 104 of the insulation panel 100 may be made from a variety of flexible materials capable of withstanding inclement weather conditions. The material of the cover 104 may be strong, tough, durable, lightweight, flexible (even at low temperatures), weather resistant, and/or water resistant. The material of the cover 104 may also be UV or sunlight resistant, wind resistant, tear/puncture resistant, chemical resistant, mildew resistant, insect/rodent resistant, and/or biodegradable. The cover 104 may also be repaired if punctured, torn, or otherwise damaged, such as with a heat sealable patch.

A fabric may be used for the cover 104 of the insulation panel 100. The fabric may be a coated fabric, such as the geo-membrane material used as pond or pit liners. The fabric material may be made, for example, of a medium or high density polyethylene, various polyesters, reinforced polyethylene, ethylene propylene diene monomer (EPDM), polyvinyl chloride (PVC), and/or polypropylene material. The fabric may be knitted, woven or nonwoven. The material may be a variety of weights, such as from about 5 to about 40 oz/sq yd. Other materials, such as Kevlar, may also be used for the cover 104 of the insulation panel 100.

As shown, the cover 104 of the insulation panel 100 is made from a geo-membrane material known as 3812 PFR LTC Low Temperature Use Geomembrane, manufactured by Seaman Corporation. Test method details about this material can be found in Table 1 below. This material may be supplied in sheets, or rolls, with a nominal weight of about 12 oz/sq yd. This material is capable of withstanding inclement weather conditions and is flexible at temperatures as low as −67 degrees F. This material is also water resistant, weather resistant, durable, tough, UV or sunlight resistant, and tear/puncture resistant.

TABLE 1
3812 PFR LTC

| | |
|---|---|
| Base Fabric Type | Polyester |
| Coating Type | Flexible Modified PVC |
| Finished Coated Weight | 12.3 oz/yd² |
| ASTM D751 | |
| Adhesion | 8 lb_{f}/in |
| ASTM D751, Dielectric Weld | |
| Tongue Tear | 8″ × 10″ sample |
| ASTM D751 | @ 12 in/min |
| | 120/122 lb_{f} |
| Grab Tensile | 381/403 lb_{f} |
| ASTM D751 | |
| Strip Tensile | 301/278 lb_{f}/in |
| ASTM D751, Procedure B | |
| Flame Self Extinguish Time | Warp - 4.3 sec. |
| ASTM D6413 | Fill - 2.1 sec. |
| Flame Char Length | Warp - 3.5″ |
| ASTM D6413 | Fill - 3.0″ |

The cover 104 of the insulation panel 100 may be a variety of colors. The color of the cover 104 may affect the UV resistance and thermal properties of the insulation panel 100. For example, a black cover will tend to absorb more thermal radiation during the day than a lighter color. However, a lighter colored cover (e.g., white or light grey) may have better UV resistance and lower emissivity than a darker colored cover.

Further, the color of the cover 104 may be useful to identify missing insulation panels 100 or portions of a pipeline that may not be insulated. For example, in one embodiment, the color of the cover 104 is different than the color of pipeline (e.g., the pipeline is grey and the cover is white). As such, a person or machine monitoring the pipeline (e.g., flying over the pipeline) will be able to more readily identify a missing insulation panel 100 or section of the pipeline that is not insulated.

However, in other embodiments, the cover 104 of the insulation panel 100 is substantially similar to the color of the pipeline and/or existing insulation system (e.g., both pipeline and the cover are grey). As such, the possibility of the surrounding environment being disrupted (e.g., wildlife spooked, eyesore, etc.) by the presence of the insulation panel 100 is reduced because the color of the panel is substantially similar to the color of the pipeline or existing insulation system. Further, the possibility of the insulation panel 100 being stolen or otherwise removed is reduced because it is more difficult to detect the presence of the panel from a distance. In these embodiments, a person or machine monitoring the pipeline may be able to identify a missing insulation panel 100 or section of the pipeline that is not insulated by comparing the difference in thickness between an insulated and non-insulated section of the pipeline or existing insulation system.

The insulation material 102 of the insulation panel 100 may be a variety of flexible insulation materials capable of reducing heat loss from the pipeline or other structure. For example, the insulation material 102 may be selected to prohibit fluids (e.g., water) in a pipeline from freezing when the pipeline is exposed to low temperatures (e.g., −65 degrees F.). The insulation material 102 may be lightweight and have a uniform thickness and/or density, though this does not have to be the case. The thickness and/or density of the insulation material 102 preferably remains substantially unchanged over a period of time (e.g., 10-20 years). The insulation material 102 may be configured such that it does not slide or move within the cover 104 (e.g., downward) when wrapped around a pipeline. The insulation material 102 may also be flexible at low temperatures (e.g., −65 degrees F.) such that the insulation panel 100 may be wrapped around a pipeline in cold weather regions of the world. The insulation material 102 may be capable of being compressed (e.g., for packaging and/or transport) and then return substantially back to its original thickness and density when decompressed or released (e.g., for installation). In this form, insulation material 102 preferably includes the ability to be compressed, densified, or otherwise deformed under pressure and the ability to return to its original density, state or form upon removal of the compressing force or pressure.

A wide variety of different types of insulation materials and combinations of different types of insulation materials may be used. Examples of suitable insulation materials include, but are not limited to, fiberglass, foam, rock wool, and/or aerogels. In addition, the insulation material 102 may also comprise mineral, organic, cellulose, and/or polymer based insulation. Further, the insulation material 102 may comprise “blown-in” or loosefill insulation, such as AttiCat® Expanding Blown-In Fiberglass insulation manufactured by Owens Corning, or a spray foam insulation. Combinations of any of the aforementioned materials may also be used.

The insulation material 102 may include one or more pieces of fiberglass insulation or other insulation having an R-value per inch of thickness from about 2 to about 10 hr-sq ft-deg F./Btu or a K-value from about 0.1 to about 0.5 Btu-in/hr-sq ft-deg F., measured at 75 deg F. Further, the insulation material 102 may include one or more pieces of fiberglass insulation or other insulation having a density from about 1.0 to about 5.0 lb/cu ft and a thickness from about 2.0 to about 16.0 inches.

The overall thermal resistance of the insulation material 102 may be increased or decreased depending on the thickness of the insulation material. For example, doubling the thickness of the insulation material 102 may double the R-value of the insulation material, tripling the thickness of the insulation material may triple the R-value, and so forth.

The thermal resistance of the insulation material 102 may be selected based on a desired increase in the overall thermal resistance of an existing insulation system for a pipeline. For example, the insulation material 102 may be selected to increase the overall R-value of the existing pipeline insulation system by two to five times. In one embodiment, the R-value of an insulation system for a pipeline without an insulation blanket 100 is from about 8 to about 15 hr-sq ft-deg F./Btu, measured at 75 deg F. This overall R-value of the pipeline insulation system is increased to between about 60 and 80 hr-sq ft-deg F./Btu when an insulation blanket 100 having a fiberglass insulation material 102 with a thickness of about 12 inches and an R-value from about 47 to about 70 hr-sq ft-deg F./Btu, measured at 75 deg F., is wrapped around the existing insulation system. This increase in the R-value is about 4.5 times the R-value of the existing pipeline insulation system without the insulation blanket 100. Further, the amount of the increase in the overall thermal resistance of the pipeline insulation system may be selected by altering the thickness, density, R-value, and/or type of insulation material 102 in the insulation panel 100.

In one embodiment, the insulation material 102 comprises TRS-40 fiberglass manufactured by Owens Corning. This insulation material has a nominal density of about 2.5 lb/cu ft. A 4 inch thick piece of this insulation material has an R-value from about 18.0 to about 18.4 hr-sq ft-deg F./Btu-and a K-value from about 0.21 to about 0.23 Btu-in/hr-sq ft-deg F., measured at 75 deg F. This insulation material is flexible at low temperatures (e.g., −65 degrees F.). This insulation material is capable of being compressed and then return substantially back to its original thickness and density when decompressed or released. In other embodiments, multiple pieces of insulation having the same or different properties and shapes can be used to form insulation material 102.

In another embodiment, the insulation material 102 comprises TRS-30 fiberglass manufactured by Owens Corning. This insulation material has a nominal density of about 1.76 lb/cu ft. A 4 inch thick piece of this insulation material has an R-value from about 16.7 to about 18.2 hr-sq ft-deg F./Btu-and a K-value from about 0.22 to about 0.24 Btu-in/hr-sq ft-deg F., measured at 75 deg F. This insulation material is flexible at low temperatures (e.g., −65 degrees F.). This insulation material is capable of being compressed and then return substantially back to its original thickness and density when decompressed or released. In other embodiments, multiple pieces of insulation having the same or different properties and shapes can be used to form insulation material 102.

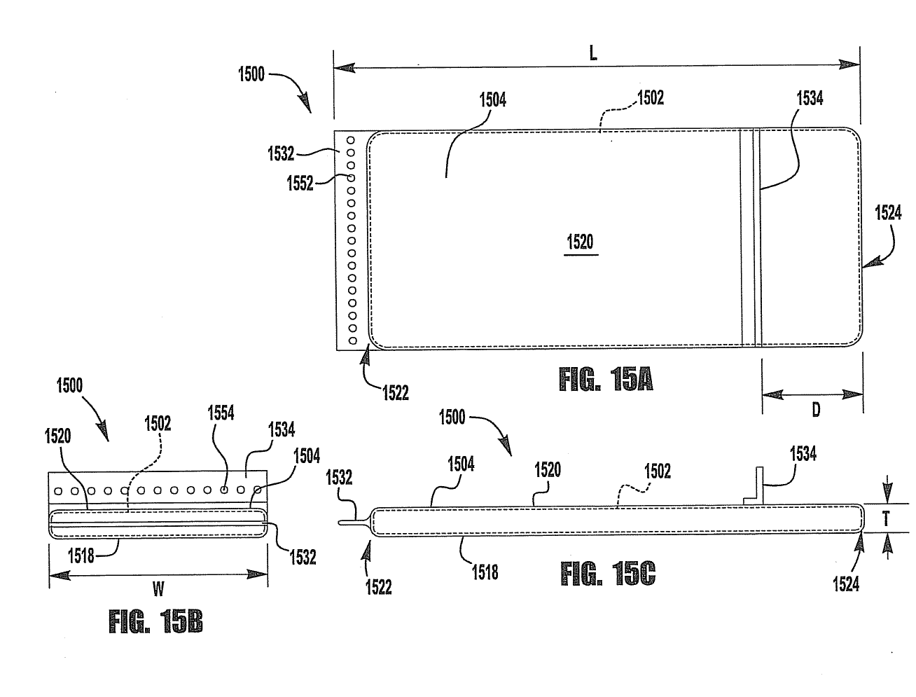

FIGS. 2A and 2B illustrate an insulation panel 200 installed on a pipeline 206. FIG. 2A is a side view and FIG. 2B is an end view of the insulation panel 200 installed on the pipeline 206. The pipeline 206 is shown for illustrative purposes and may include one or more components in addition to the pipe through which the fluid is intended to flow. For example, pipeline 206 may include existing insulation material 1402 (see FIG. 14) wrapped around the pipeline (e.g., encased in a hard outer shell 1404, as shown in FIG. 14) or a junction connecting two or more lengths of pipe together (see FIG. 4D).

When the insulation panel 200 is installed on a pipeline having existing insulation, the insulation panel may be installed over the existing insulation to provide additional insulation to the pipeline. As such, the insulation panel 200 may be used to increase the overall R value of the pipeline insulation, such as, for example, doubling or tripling the overall R value of the existing insulation. Other exemplary applications of the insulation panel 200 include insulating pipelines having no existing insulation or re-insulating pipelines in which the existing insulation is removed and replaced by one or more insulation panels.

In the embodiment shown, the insulation panel 200 is wrapped around the circumference or outer surface of the pipeline 206 and about a longitudinal axis 208 of the pipeline. When installed, the bottom surface 218 of the insulation panel 200 contacts the outer surface of the pipeline 206 (see FIG. 2B) and the top surface 220 is exposed to the environment. In some embodiments, the portion of the cover 204 that includes the top surface 220 may be made of a different material or even the same material having characteristics (e.g., size, thickness, density, etc.) different from the portion of the cover that includes the bottom surface 218. For example, outer or top portion 220 of the cover 204 may be made of a material that is more durable than an inner or bottom portion 218 of the cover due to its exposure to the environment and other potential hazards.

Further, the insulation panel 200 is dimensioned such that the third and fourth sides 226 and 228 of the panel intersect or can overlap when the panel is wrapped around the pipeline 206. The intersection of the third and fourth sides 226 and 228 is shown at the bottom of the pipeline 206 in FIG. 2B. However, the insulation panel 200 may be positioned such that the intersection of the third and fourth sides 226 and 228 is at any location along the circumference of the pipeline 206 and, hence, the panel 200.

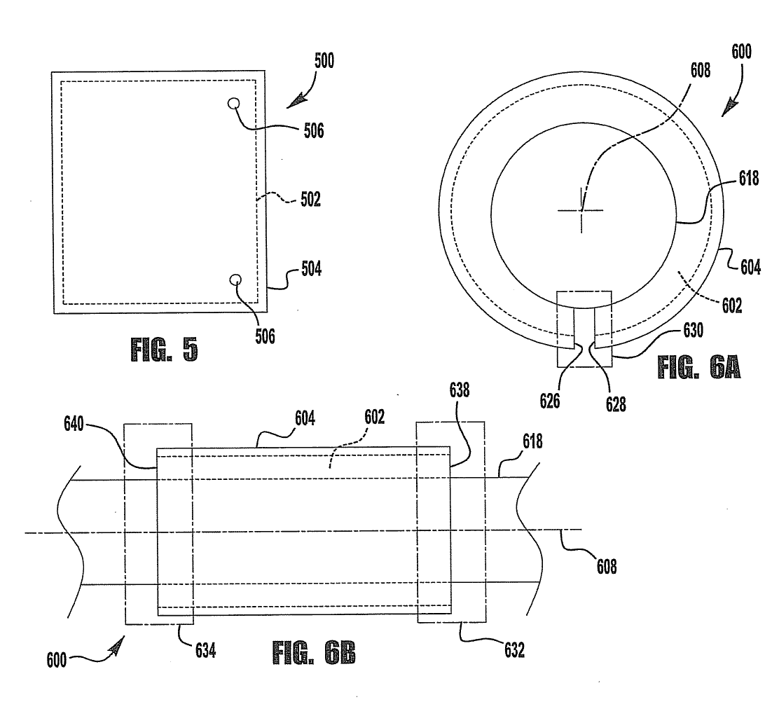

As discussed in more detail below in reference to FIGS. 6A-8B, the insulation panel 200 may be secured to pipeline 206 or other structures in a variety of different ways. For example, the third and fourth sides 226 and 228 may be secured together and/or to the pipeline 206 directly, the first and second sides 222 and 224 may be secured to the pipeline directly, and/or the first and second sides 222 and 224 may be secured to an adjacent insulation panel.

FIGS. 15A-15C illustrate an insulation panel 1500 according to an embodiment of the present application. The insulation panel 1500 comprises a cover 1504 and an insulation material 1502. The insulation material 1502 is encased within the cover 1504 to form a blanket like structure. The cover 1504 may fit tightly or loosely around the insulation material 1502. The cover 1504 and the insulation material 1502 may comprise any one or any combination of cover and insulation materials described herein.

As illustrated in FIG. 15A, the insulation panel 1500 is rectangular in shape. The insulation panel 1500 has a length L from about 12 to about 23 feet, a width W from about 1.5 to about 10 feet, and a thickness T from about 3 to about 16 inches. As such, the insulation panel 1500 is configured such that it may be installed around a pipeline or an existing insulation system on a pipeline having a diameter from about 24 to about 78 inches. Further, the insulation panel 1500 weighs from about 25 to about 550 lbs. In one embodiment, the insulation panel 1500 is about 21 feet long (L), about 6 feet wide (W), about 12 inches thick (T), weighs about 225 lbs., and is configured to be installed on a pipeline or an existing insulation system on a pipeline having a diameter of about 56 inches or less.

As illustrated in FIGS. 15A-15C, the insulation panel 1500 includes a top surface 1520, a bottom surface 1518, a first end 1522, a second end 1524, a first fastening portion 1532, and a second fastening portion 1534. The first fastening portion 1532 is configured as a flap extending outward from the first end 1522 of the insulation panel 1500. As shown, the first fastening portion 1532 extends along the first end 1522 the entire width W of the insulation panel 1500.

The second fastening portion 1534 is configured as a flap extending outward from the top surface 1520 of the insulation panel 1500. As shown, the second fastening portion 1534 optionally extends along the top surface 1520 the entire width W of the insulation panel 1500 and is substantially parallel to the first and second ends 1522 and 1524 of the panel and the first fastening portion 1532. The second fastening portion 1534 is also positioned at a distance D from the second end 1524 of the insulation panel 1500. The distance D is between about 6 and 24 inches from the second end 1524 of the insulation panel 1500. In one embodiment, the second fastening area 1534 is positioned about 9 inches from the second end 1524 of the insulation panel 1500.

The first and second fastening portions 1532 and 1534 may be formed in a variety of ways. For example, the fastening portions 1532 and 1534 may be formed by fastening or sealing one or more pieces of the cover material together to form a flap. The one or more pieces of the cover material may be sealed or fastened together in a variety of ways, such as, for example, with fasteners, adhesives, heat sealed, or the like. Further, the fastening portions 1532 and 1534 may comprise one or more pieces of material attached to the insulation panel 1500, e.g., secured to the cover 1504 of the insulation panel with fasteners, adhesives, heat sealed, or the like. Further, the first and second fastening portions 1532 and 1534 include openings 1552 and 1554 extending along the width of the fastening portion and configured for receipt of a fastener or other like means to secure the insulation panel 1500 to a pipeline or other structure. The openings 1552 and 1554 may be reinforced, e.g., with grommets.

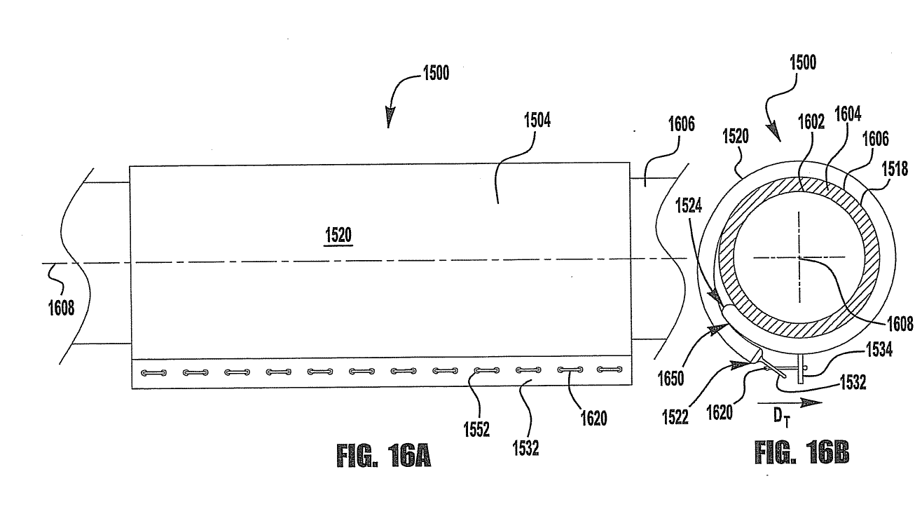

FIGS. 16A and 16B illustrate the insulation panel 1500 installed on a pipeline 1602 having an existing insulation material 1604 encased in a hard outer shell 1606. FIG. 16A is a side view and FIG. 16B is an end view of the insulation panel 1500 installed on the pipeline 1602.

As illustrated in FIGS. 16A and 16B, the insulation panel 1500 is wrapped around the circumference or outer surface of the outer shell 1606 and about a longitudinal axis 1608 of the pipeline. When installed, the bottom surface 1518 of the insulation panel 1500 contacts the outer surface of the outer shell 1606 (see FIG. 16B) and the top surface 1520 is exposed to the environment. Further, the insulation panel 1500 is dimensioned such that the first end 1522 of the panel overlaps the second end 1524 when the panel is wrapped around the outer shell 1606. The corresponding ends of the insulation material 1502 also overlap when the insulation panel 1500 is wrapped around the outer shell 1606 such as to prohibit a gap in the insulation around the shell.

The first and second fastening portions 1532 and 1534 of the insulation panel 1500 are drawn toward one another with a connector 1620 to secure the panel to the pipeline 1602. The connector 1620 may be a variety of devices capable of drawing the first and second fastening portions 1532 and 1534 of the insulation panel 1500 together. For example, the connector 1620 may be one or more fasteners (e.g., a bolt, clip, pin, hook and loop, hog ring, or the like) or an elongated flexible member, such as a rope, cord, band, chain, or the like. As illustrated in FIGS. 16A and 16B, the connector 1620 is an elongated flexible member routed through the openings 1552 and 1554 of the first and second fastening portions 1532 and 1534 to pull the fastening portions together.

As illustrated in FIG. 16B, the configuration of the insulation panel 1500 permits the first and second ends 1522 and 1524 to overlap when installed about the pipeline 1602 and the outer shell 1606. As such, when the connector 1620 is tightened, the first fastening portion 1532 is pulled in a direction D_{T} toward the second fastening portion 1534 and the insulation panel 1500 is tightened against the outer surface of the outer shell 1606. Further, the top surface 1520 of the insulation panel 1500 presses against the bottom surface 1518 at area 1650, which may form a seal that prohibits heat from escaping between the ends 1522 and 1524 of the insulation panel. Further, the overlap of the first and second ends 1522 and 1524 and the drawing of the fastening portions 1532 and 1534 toward one another permits the insulation panel 1500 to be installed on pipelines (or existing insulation systems) having various diameters. For example, the connector 1620 may be tightened or loosened to accommodate pipelines having various diameters.

The insulation panel of the present application may be secured to a pipeline or other structure in a variety of ways. One exemplary method includes securing two sides of the insulation panel together when the panel is wrapped around the pipeline. FIG. 6A illustrates an end view of an insulation panel 600 wrapped around a pipeline 618. As shown, a first side 626 and a second side 628 of the insulation panel 600 may be secured together with a first connector 630 to prohibit removal of the panel from the pipeline 618. The first connector 630 may be a variety of devices capable of securing the first and second sides 626 and 628 of the insulation panel 600 together. For example, the first connector 630 may be one or more fasteners (e.g., a bolt, clip, pin, hook and loop, hog ring, or the like) or an elongated flexible member, such as a rope, band, cord, chain, or the like. The first connector 630 may also be a piece of flexible or non-flexible material, such as a plate, that is attached to both the first and second sides 626 and 628 to secure the sides together. Further, the first and second sides 626 and 628 of the insulation panel 600 may overlap to permit installation of the panel on pipelines of various diameters.

The insulation panel of the present application may include flanges or flaps on one or more sides of the panel for securing the panel to a pipeline. One or more of the flanges or flaps may be positioned along the length of a side or a single flange or flap may run the entire length of the side. FIG. 7A illustrates an insulation panel 700 having a first flange 726 with one or more openings 730 and a second flange 728 with one or more openings 732. The first and second flanges 726 and 728 are located on two opposing sides of the insulation panel 700. The openings 730 and 732 in the first and second flanges 726 and 728 may be reinforced, e.g., grommets. The openings 730 and 732 may be configured for receipt of one or more fasteners.

FIGS. 7B and 7C illustrate the insulation panel 700 installed on a pipeline 718. FIG. 7B is a side view and FIG. 7C is an end view of the insulation panel 700 installed on the pipeline 718. As shown, the insulation panel 700 is wrapped around the circumference or outer surface of the pipeline 718 and about a longitudinal axis 708 of the pipeline. When installed, the first and second flanges 726 and 728 of the insulation panel 700 are configured to meet at the bottom of the pipeline 718 to secure the opposing sides of the panel together. However, the insulation panel 700 may be positioned such that the first and second flanges 726 and 728 meet at any location around the circumference of the pipeline 718 (e.g., top or sides). As shown, the openings 730 and 732 in the first and second flanges 726 and 728 are substantially aligned such that one or more fasteners or an elongated flexible member, such as a rope, cord, chain, band, or the like, may be used to fasten the flanges together and secure the insulation panel 700 to the pipeline 718. As shown in FIGS. 7B and 7C, hog rings 740 pass through openings 730 and 732 in the first and second flanges 726 and 728 to fasten the flanges together.

Another exemplary method of securing the insulation panel of the present application to a pipeline includes securing one or more sides of the panel to the pipeline or component of the pipeline. This exemplary method may prohibit the insulation panel from moving longitudinally relative to the pipeline. FIG. 6B illustrates a side view of the insulation panel 600 installed on the pipeline 618. As shown, a third side 638 and a fourth side 640 of the insulation panel 600 may be secured to the pipeline 618 with a second connector 632 and a third connector 634, respectively. The second and third connectors 632 and 634 may be a variety of devices capable of securing the third and fourth sides 638 and 640 of the insulation panel 600 to the pipeline 618. For example, the second and/or third connectors 632 and 634 may be one or more fasteners, such as a bolt, clip, pin, or the like, that attaches the side of the insulation panel 600 to the pipeline 618. Further, the second and/or third connectors 632 and 634 may include an elongated flexible member, such as a rope, cord, chain, band, or the like, that secures the side of the insulation panel 600 around the pipeline 618. The third and fourth sides 638 and 640 and/or the second and third connectors 632 and 634 may be configured to permit installation of the insulation panel 600 on pipelines of various diameters.

FIG. 8A illustrates an insulation panel 800 having a first flange 826 with one or more openings 830 and a second flange 828 with one or more openings 832. The first and second flanges 826 and 828 are located on two opposing sides of the insulation panel 800. The openings 830 and 832 in the first and second flanges 826 and 828 may be reinforced, e.g., grommets. The openings 830 and 832 may be configured for receipt of one or more fasteners (e.g., a bolt, clip, pin, or the like) or an elongated flexible member, such as a rope, cord, chain, band, or the like.

FIG. 8B illustrates a side view of an insulation panel embodiment 800 installed on a pipeline 818 or other similar structure. The insulation panel 800 is wrapped around the circumference or outer surface of the pipeline 818 and about a longitudinal axis 808 of the pipeline. When installed, the first and second flanges 826 and 828 of the insulation panel 800 are configured to wrap around the circumference or outer surface of the pipeline 818. As shown, two lengths of elongated flexible members 850 and 852 are threaded through the openings 830 and 832 in the first and second flanges 826 and 828, respectively. The lengths of the elongated flexible members 850 and 852 may be tightened to draw the first and second flanges 826 and 826 against the outer surface of the pipeline 818 to secure the insulation panel 800 to the pipeline. The lengths of the elongated flexible members 850 and 852 may be tightened or loosened such that the insulation panel 800 may be secured to pipelines of various diameters. Further, the arrangement of the openings 830 and 832 in the first and second flanges 826 and 828 may permit the insulation panel 800 to be secured to pipelines of various diameters.

As described above, the insulation panel of the present application may be secured to the pipeline such that the fastening means is located at any location about the circumference or outer surface of the pipeline, e.g., towards the bottom, on either side, or on top of the pipeline. With the fastening means located near the bottom of the pipeline, any moisture that builds up between the pipeline and the insulation panel may be permitted to drain out between the sides of the panel located towards the bottom of the pipeline. For example, as shown in FIG. 6A, moisture may be permitted to drain out between the first side 626 and the second side 628 of the insulation panel 600. However, locating the fastening means on the sides or top of the pipeline may discourage theft or removal of the insulation panel because the fastening means are more difficult to access.

The amount of insulation material encased within the cover of the insulation panel may vary. For example, thicker insulation or insulation having a greater thermal resistance may be required for insulation panels installed on pipelines in colder regions (e.g., low areas, areas having a lower average temperature, etc.) than those in warmer regions to prohibit fluid in the pipeline from freezing. The insulation panels of the present application may be configured to permit more insulation material and/or a non-uniform distribution of insulation material to be encased within the cover of the panel. For example, an insulation panel may include one or more layers of insulation material arranged in various configurations or patterns within the cover. Further, different types of insulation material may be encased within the cover of the insulation panel. For example, insulation material having a higher R-value or greater thermal resistance may be included in insulation panels installed on pipelines in colder regions.

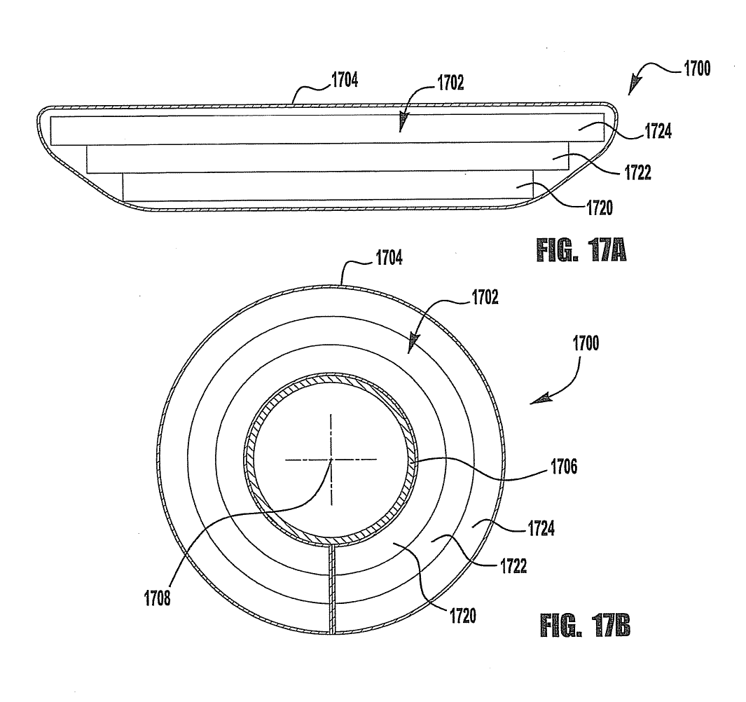

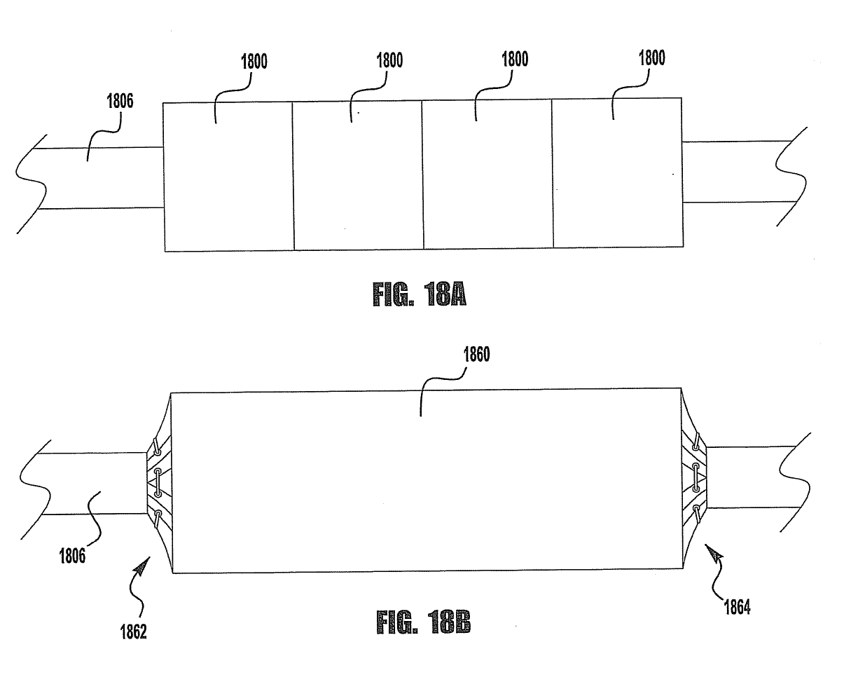

FIGS. 17A and 17B illustrate an insulation panel 1700 according to an embodiment of the present application. The insulation panel 1700 includes multiple layers 1720, 1722, and 1724 of insulation material arranged within a cover 1704 of the panel. The layers 1720, 1722, and 1724 of insulation material form a non-uniform arrangement of insulation 1702 that facilitates installation of the insulation panel 1700 on a pipeline 1706 or other structure.

As illustrated in FIG. 17A, the insulation panel 1700 comprises three layers 1720, 1722, and 1724 of insulation material stacked within the cover 1704 of the insulation panel 1700 to form the arrangement of insulation 1702. However, in other embodiments, more or less layers of insulation material may be used, for example, two or four layers of insulation material may be stacked within the cover 1704. As shown, the outer layer 1724 of insulation material is longer than the middle layer 1722 of insulation material and the middle layer is longer than the inner layer 1720 of insulation material.

As illustrated in FIG. 17B, the inner layer 1720 of insulation material is configured to wrap around the circumference or outer surface of the pipeline 1706 and about a longitudinal axis 1708 of the pipeline. The inner layer 1720 of insulation material is configured such that the ends intersect and/or overlap when installed on the pipeline 1706. The middle layer 1722 of insulation material is longer than the inner layer 1720 such that, when wrapped around the inner layer and the pipeline 1706, the ends of the middle layer intersect and/or overlap. Similarly, the outer layer 1724 of insulation material is longer than the middle layer 1722 such that, when wrapped around the inner layer 1720, middle layer, and the pipeline 1706, the ends of the outer layer intersect and/or overlap.

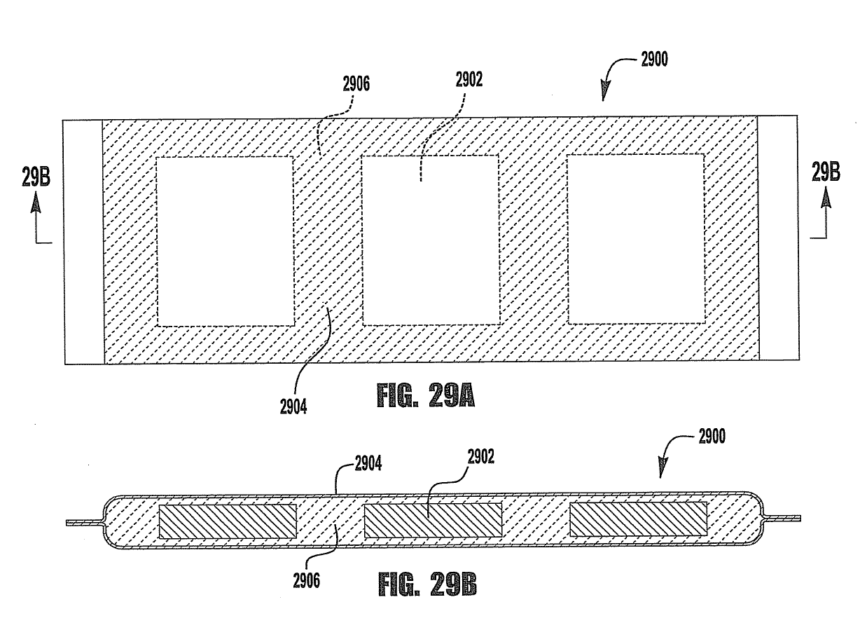

FIGS. 28A and 28B illustrate an insulation panel 2800 according to an embodiment of the present application. The insulation panel 2800 includes an insulation material 2802 encased within a cover 2804 of the panel. As illustrated in FIG. 28B, the insulation panel 2800 is configured to wrap around the circumference or outer surface of a pipeline 2806 and about a longitudinal axis 2808 of the pipeline. The insulation material 2802 of the insulation panel 2800 includes angled first and second ends 2830 and 2832 that facilitate installation of the panel on the pipeline 2806 or other structure. The first and second ends 2830 and 2832 are angled such that the outer surface of the insulation material 2802 is longer than the inner surface of the insulation material. As such, the first and second ends 2830 and 2832 intersect when the insulation panel 2800 is installed on the pipeline 2806 with the inner surface of the insulation material 2802 facing the pipeline.

The insulation panel of the present application may be manufactured in a variety of different ways. For example, one or more pieces of cover material may be wrapped around the insulation material. One or more sides of the cover material may then be fastened or sealed together to encase the insulation material. The sides of the cover material may be sealed or fastened in a variety of ways, e.g., with fasteners, adhesives, heat sealed, or the like. Further, one or more sides of the cover material may be fastened or sealed to form an outer portion along the sides of the cover.

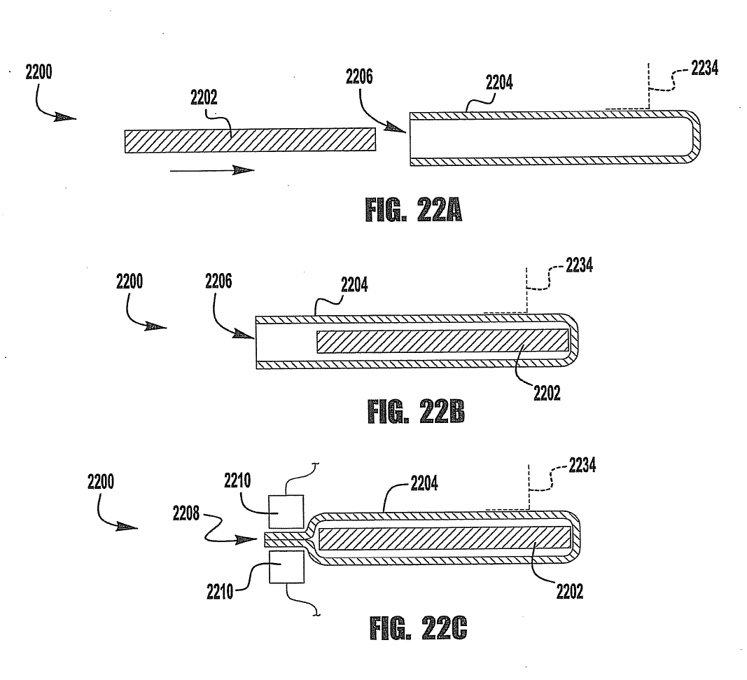

FIGS. 22A-22C illustrate an exemplary method of manufacturing an insulation panel 2200 according to an embodiment of the present application. As illustrated in FIGS. 22A and 22B, one or more pieces of insulation material 2202 are inserted into an open end 2206 of a pouch or bag of cover material 2204. As illustrated in FIG. 22C, a heat sealer 2210 seals the open end 2206 of the cover material 2204 to form an outer portion 2208, such as, for example, a flange or flap that may be configured as a fastening portion to secure the insulation panel 2200 to a pipeline. However, in some embodiments, the heat seal may or may not include an outer portion for fastening the insulation panel 2200 to a pipeline, e.g., the heat seal may only form a seam between the portions of the cover material 2204. An optional fastening flange or flap 2234 may also be formed from the cover material 2204 and/or attached to the cover material before, after, or during the manufacturing of the insulation panel 2200. As shown, the fastening flap 2234 may be attached to a surface of the cover material 2204 prior to insertion of the one or more pieces of insulation material 2202 into the open end 2206 of the cover material. The fastening flap 2234 may be used in the same manner the flap 1534 is used (see FIGS. 16A and 16B).

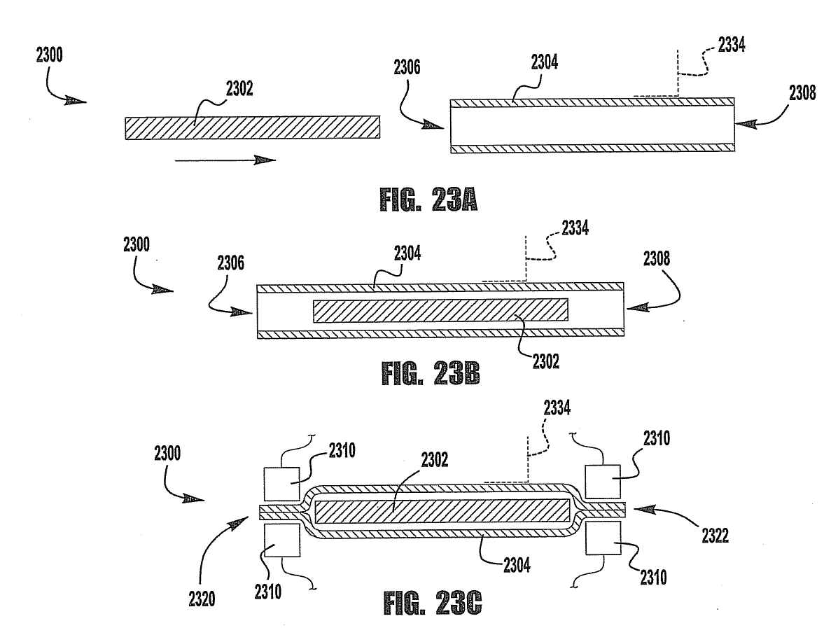

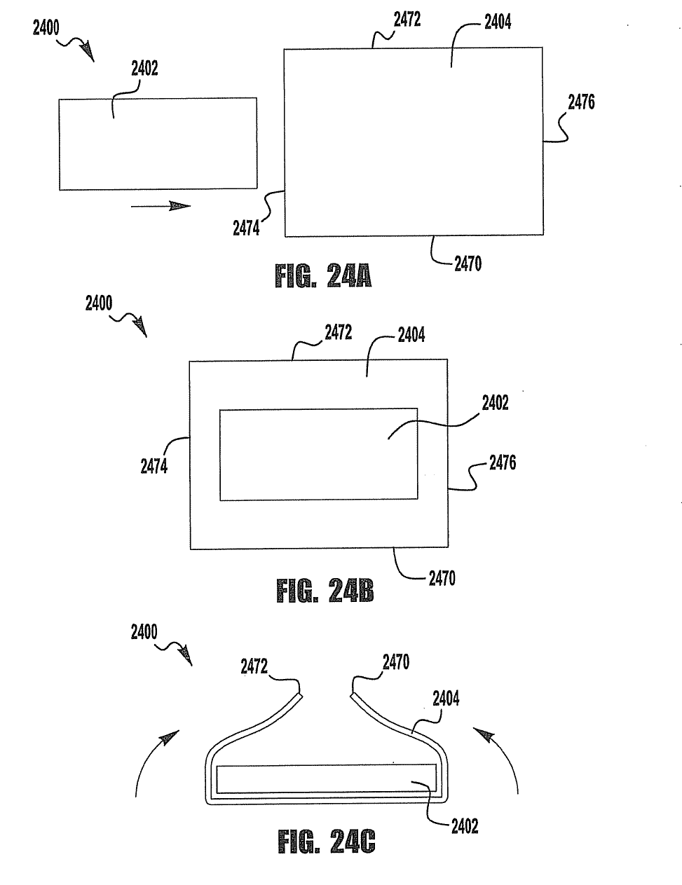

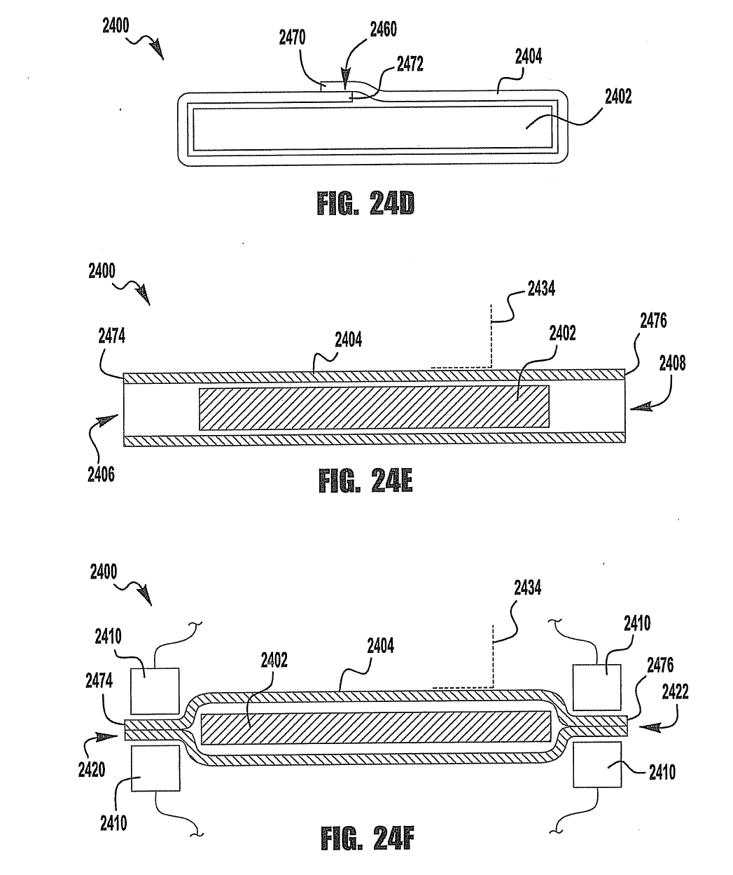

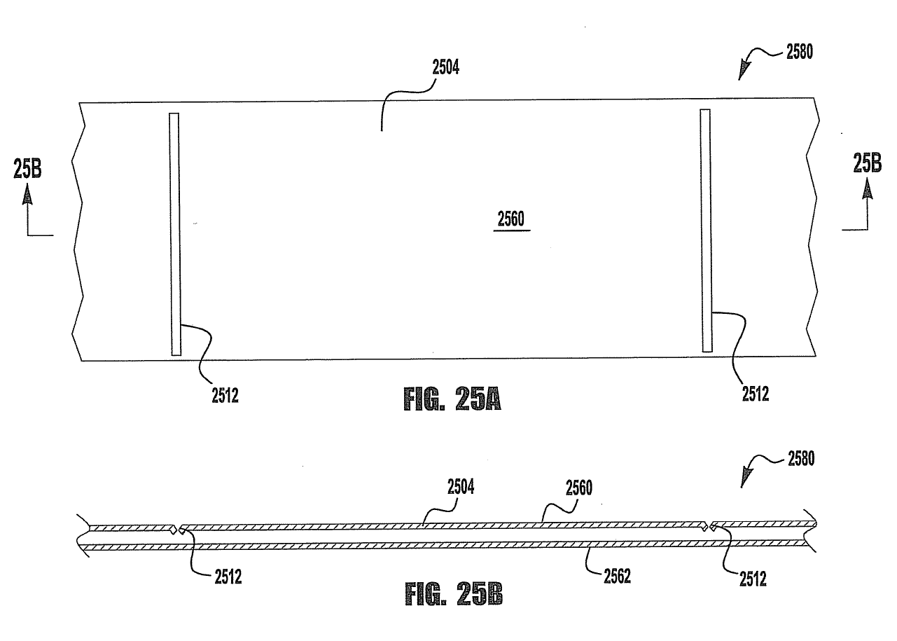

FIGS. 23A-23C illustrate an exemplary method of manufacturing an insulation panel 2300 according to an embodiment of the present application. As illustrated in FIGS. 23A and 23B, one or more pieces of insulation material 2302 are inserted into a first open end 2306 of a tube of cover material 2304. As illustrated in FIG. 23C, a heat sealer 2310 seals the first open end 2306 and a second open end 2308 of the cover material 2304 to form a first outer portion 2320 and a second outer portion 2322, respectively. The outer portions 2320 and 2322 may be a flange or flap configured as a fastening portion to secure the insulation panel 2300 to a pipeline. However, in some embodiments, the heat seal may or may not include an outer portion for fastening the insulation panel 2300 to a pipeline, e.g., the heat seal may only form a seam between the portions of the cover material 2304. An optional fastening flange or flap 2334 may also be formed from the cover material 2304 and/or attached to the cover material before, after, or during the manufacturing of the insulation panel 2300. As shown, the fastening flap 2334 may be attached to a surface of the cover material 2304 prior to insertion of the one or more pieces of insulation material 2302 into the first open end 2306 of the cover material. The fastening flap 2334 may be used in the same manner the flap 1534 is used (see FIGS. 16A and 16B).

FIGS. 24A-24F illustrate an exemplary method of manufacturing an insulation panel 2400 according to an embodiment of the present application. As illustrated in FIGS. 24A and 24B, one or more pieces of insulation material 2402 are placed on a piece of cover material 2404 having a first side 2470, a second side 2472, a third side 2474, and a fourth side 2476. As illustrated in FIGS. 24C and 24D, the first and second sides 2470 and 2472 are folded around the one or more pieces of insulation material 2402. The first side 2470 overlaps with the second side 2472 to form a fastening area 2460. The first side and second side 2470 and 2472 are sealed or fastened together at the fastening area 2460 to form a tube of cover material 2404. The first and second sides 2470 and 2472 may be sealed or fastened together in a variety of ways, such as, for example, with fasteners, adhesives, heat sealed, or the like. As illustrated in FIG. 24E, the third and fourth sides 2474 and 2476 of the cover material 2404 form a first open end 2406 and a second open end 2408 of the tube, respectively.

As illustrated in FIGS. 24E and 24F, a heat sealer 2410 seals the first open end 2406 and the second open end 2408 of the cover material 2404 to form a first outer portion 2420 and a second outer portion 2422, respectively. The outer portions 2420 and 2422 may be a flange or flap configured as a fastening portion to secure the insulation panel 2400 to a pipeline. However, in some embodiments, the heat seal may or may not include an outer portion for fastening the insulation panel 2400 to a pipeline, e.g., the heat seal may only form a seam between the portions of the cover material 2404. An optional fastening flange or flap 2434 may also be formed from the cover material 2404 and/or attached to the cover material before, after, or during the manufacturing of the insulation panel 2400. As shown, the fastening flap 2434 may be attached to a surface of the cover material 2404 prior to insertion of the one or more pieces of insulation material 2402 into the first open end 2406 of the cover material. The fastening flap 2434 may be used in the same manner the flap 1534 is used (see FIGS. 16A and 16B).

One or more openings may be placed in the cover material before, after, or during the manufacturing of the insulation panel, e.g., openings may be punched in an outer portion of the cover after the cover material is applied to the insulation material. In one embodiment, the cover material is heat shrunk onto a piece of insulation material to form the insulation panel. Further, the one or more pieces of insulation material may include one or more layers of insulation material that form an arrangement of insulation.

FIGS. 25A-27B illustrate an exemplary manufacturing process for an insulation panel 2600 according to an embodiment of the present application. The manufacturing process comprises inserting one or more pieces of insulation material 2602 into a tube of cover material 2504, selectively sealing the top and bottom of the cover material together to form ends of one or more insulation panels 2600, and cutting the cover material to form individual insulation panels.

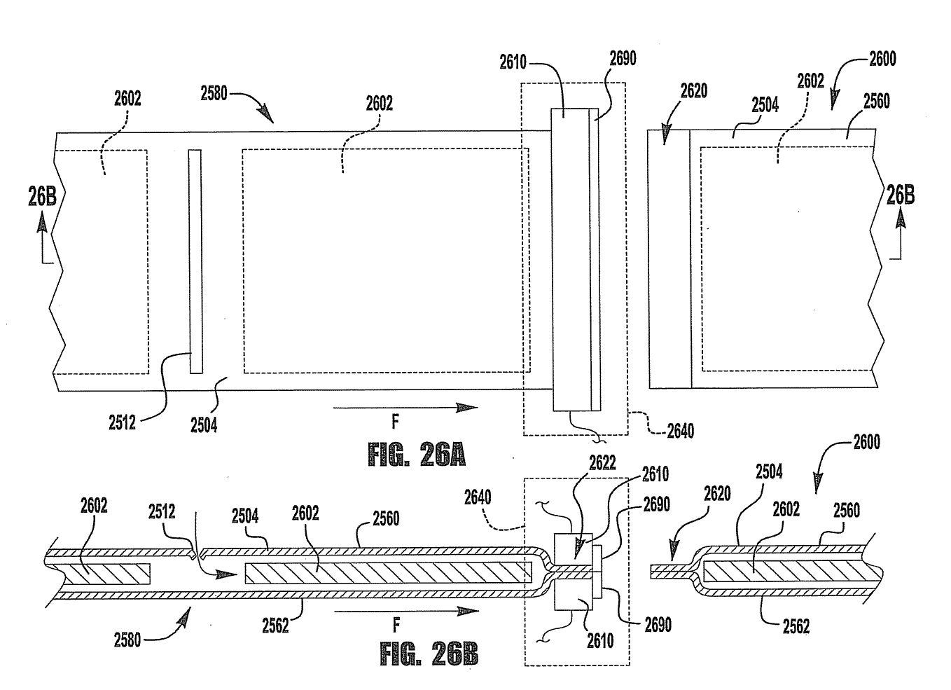

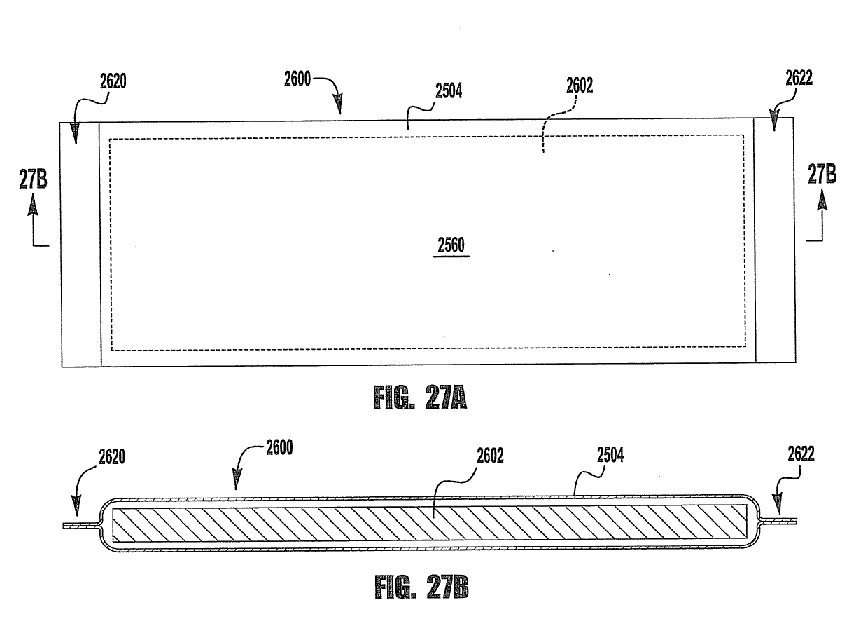

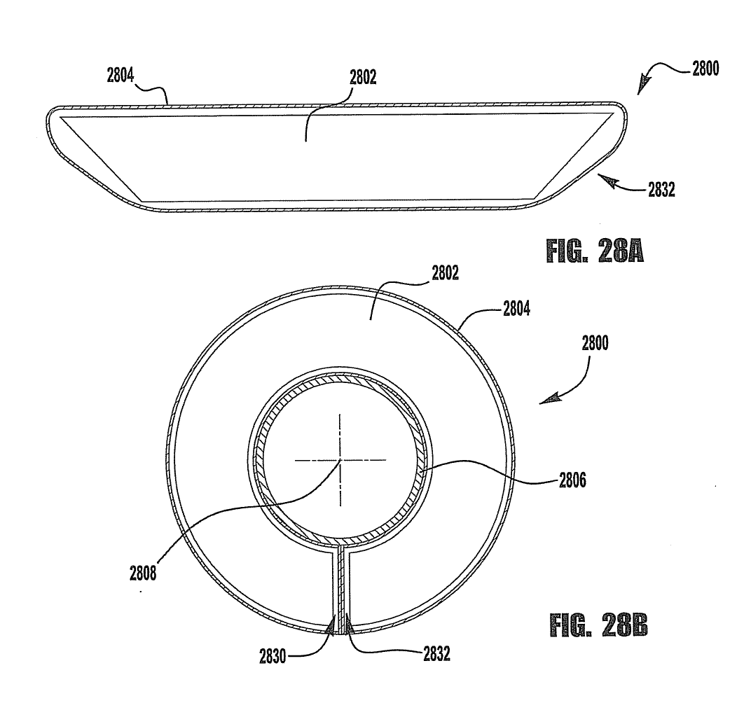

FIGS. 25A and 25B illustrate a continuous web 2580 of cover material 2504 that is used to produce one or more insulation panels 2600 (see FIGS. 26A-27B). The web 2580 is formed as a tube having a top surface 2560 and a bottom surface 2562. The web 2580 comprises slits 2512 in the top surface 2560 of the cover material 2504 that are configured to receive one or more pieces of insulation material 2602. As illustrated in FIG. 25A, the slits 2512 extend substantially the width of the web 2580 and are substantially perpendicular to the length of the web.

As illustrated in FIGS. 26A and 26B, the web 2580 of cover material 2504 is fed in a direction F through the manufacturing process. The one or more pieces of insulation material 2602 are inserted through a slit 2512 and into the web 2580 of cover material 2504 as the web travels through the manufacturing process. The web 2580 of cover material 2504 and the one or more pieces of insulation material 2602 then travel through a processing station 2640. The processing stationing 2640 includes a heat sealer 2610 that seals the top surface 2560 and the bottom surface 2562 of the cover material 2504 together. Further, the processing station 2640 comprises one or more cutting tools 2690 for cutting the cover material 2504 to form the individual insulation panels 2600.

As illustrated in FIGS. 26A and 26B, the heat sealer 2610 of the processing station 2640 seals the top surface 2560 and the bottom surface 2562 of the cover material 2504 together to form a first end 2620 of the insulation panel 2600. The web 2580 of cover material 2504 and the one or more pieces of insulation material 2602 then index and the heat sealer 2610 seals the top surface 2560 and the bottom surface 2562 of the cover material 2504 together to form a second end 2622 of the insulation panel 2600. Further, a cutting tool 2690 cuts the cover material 2504 between the first and second ends 2620 and 2622 to sever the individual insulation panels 2600. FIGS. 27A and 27B illustrate an insulation panel 2600 formed by the manufacturing process illustrated in FIGS. 26A and 26B.

The manufacturing process may also include one or more processing stations that form openings in the cover material 2504 of the insulation panel 2600 such as, for example, in one or more ends of the insulation panel. For example, the processing station 2640 may include punches that form openings in one or more ends 2620 and 2622 of the insulation panel 2600 as the heat sealer 2610 seals the top surface 2560 and the bottom surface 2562 of the cover material 2504 together. Further, the manufacturing process may include one or more processing stations that form a fastening flap and/or attach a fastening flap to a surface of the cover material 2504. The manufacturing process may also include one or more processing stations that reinforce openings in the cover material 2504 or a fastening flap, such as, for example, with grommets.

The insulation panel of the present application may include pockets inside the panel configured to hold pieces of insulation material, “blown-in” insulation material, and/or spray foam in place within the panel. The pockets may be formed within the insulation panel in a variety of ways. For example, pockets may be formed in the insulation panel by heat sealing interior portions of the cover material together (e.g., the top and bottom) to form heat seal lines. Further, interior portions of the cover material may be attached together with an adhesive or fastener to form pockets within the insulation panel (e.g., glue lines). The insulation material may be disposed in the one or more pockets in a variety of ways. For example, the insulation material may be inserted into the pockets during manufacturing of the panel. Further, openings in the cover material may be configured to permit “blown-in” insulation material or spray foam to be sprayed into the pockets.

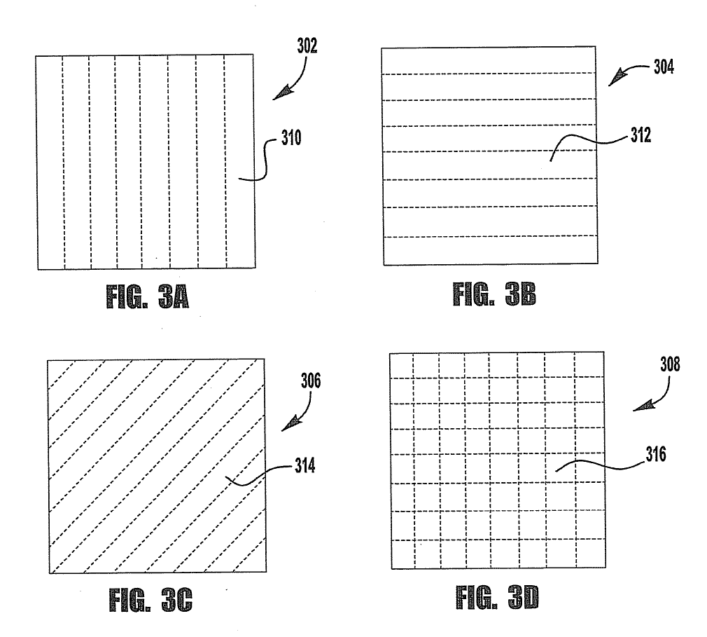

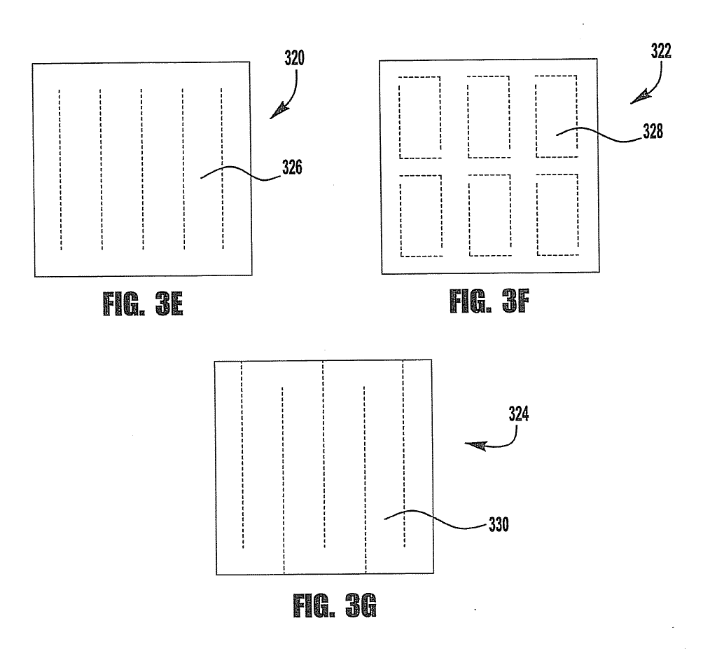

FIGS. 3A-3G illustrate various embodiments of insulation panels 302, 304, 306, 308, 320, 322, and 324 having pockets 310, 312, 314, 316, 326, 328, and 330 within the insulation panel. For example, the insulation panel 302 of FIG. 3A includes vertical pockets 310 within the panel; the insulation panel 304 of FIG. 3B includes horizontal pockets 312 within the panel; the insulation panel 306 of FIG. 3C includes angled pockets 314 within the panel; the insulation panel 308 of FIG. 3D includes a grid like structure of pockets 316 within the panel; the insulation panel 320 of FIG. 3E includes vertical pockets 326 that do not extend the entire width of the panel; the insulation panel 322 of FIG. 3F includes a maze like configuration of pockets 328 within the panel; and the insulation panel 324 of FIG. 3G includes a serpentine pattern of pockets 330 within the panel. An insulation panel having more than one pocket configuration is also possible, such as, for example, a configuration that combines any one or more of the aforementioned pockets 310, 312, 314, 316, 326, 328, and 330 may be used.

The insulation panel of the present application may have a variety of other configurations of pockets within the panel to hold pieces of insulation material, “blown-in” insulation material, and/or spray foam in place within the panel. The pockets may be configured to hold the insulation material in place within the cover when the panel is installed about a pipeline (e.g., prohibiting the insulation on top of the pipeline from moving downward within the cover). The pockets of the insulation panel may or may not extend the entire length or the entire width of the insulation panel. Further, the insulation material within the insulation panel may be secured to the cover such that the insulation material is held in place relative to the cover. The insulation material may be secured to the cover in a variety of ways, such as with one or more fasteners, adhesives, or the like.

FIGS. 29A and 29B illustrate an embodiment of an insulation panel having one or more pieces of insulation material at least partially surrounded by void filling insulation material. As shown, an insulation panel 2900 includes three pieces of an insulation material 2902, such as, for example, compressible fiberglass insulation or foam, encased within a cover 2904 of the panel. However, in other embodiments, more or less pieces of insulation material 2902 may be encased within the cover 2904 (e.g., one, two, four, five, or more). Void filling insulation material 2906, such as, for example, “blown-in” insulation material or spray foam, at least partially surrounds the pieces of the insulation material 2902 within the cover 2904. The void filling insulation material 2906 fills gaps or voids within the cover 2904 between the pieces of the insulation material 2902 and the inside of the cover. In one embodiment, the insulation panel 2900 is filled with the void filling insulation material 2906 through one or more openings in the cover 2904 of the panel. Further, the insulation panel 2900 may be filled with the void filling insulation material 2906 before, during, or after installation of the installation panel on a pipeline or other structure.

The insulation panel of the present application may be shaped and configured in a variety of ways. For example, the insulation panel may be shaped and configured such that it may be installed around components of a pipeline, e.g., pipe junctions or support structures. The insulation panel may also be shaped and configured to insulate a pipeline of varying diameter (e.g., the transition area between pipes of different diameters). Further, the insulation panel may be shaped and configured to insulate the transition area between an above ground pipeline and below ground pipeline (e.g., the intersection of the pipeline and the surface) and bends in pipelines. The insulation panel may also be shaped and configured to insulate a bend in a pipeline or a non-straight section of a pipeline.

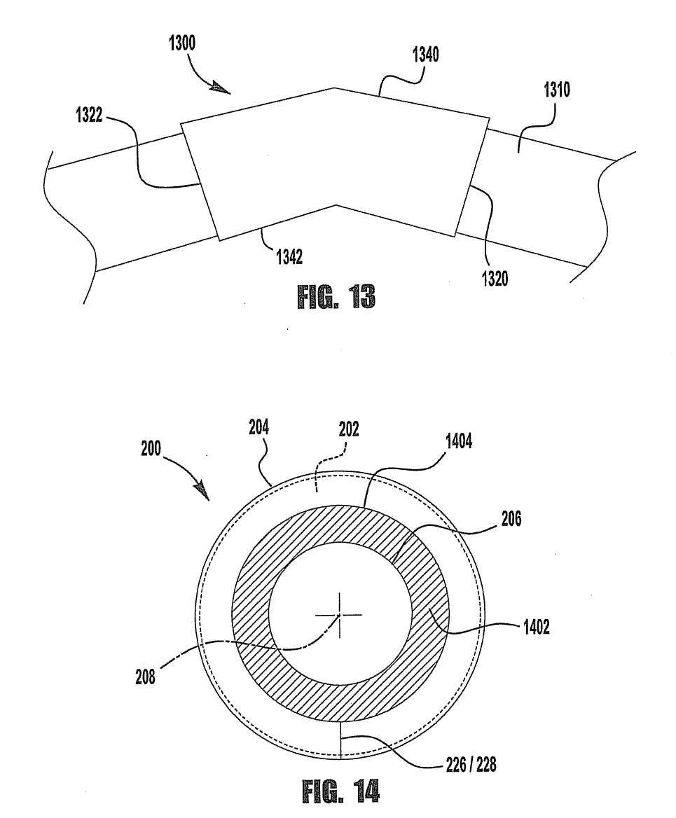

FIGS. 4A-4D and 13 illustrate various shapes and configurations of the insulation panel of the present application. An insulation panel 402 of FIG. 4A is trapezoidal in shape and has a first side 420, a second side 422, a third side 440, and a fourth side 442. One exemplary application for the insulation panel 402 is to insulate a pipeline of varying diameter. For example, the insulation panel 402 may be placed on top of the pipeline with the first side 420 positioned on the portion of the pipeline having the smaller diameter and the second side 422 positioned on the portion of the pipeline having the larger diameter. The third and fourth sides 440 and 442 of the insulation panel 402 may then be wrapped around the pipeline to insulate the transition area between the portions of the pipeline having varying diameters.

An insulation panel 404 of FIG. 4B is cross shaped and has four flap portions 424, 426, 428, and 430 extending from the central portion of the panel. One exemplary application for insulation panel 404 is to insulate a component of the pipeline. For example, the central portion of the insulation panel 404 may be placed on the top of the component and the flaps 424, 426, 428, and 430 wrapped around the sides and bottom of the component (e.g., similar to wrapping a band aid around the knuckle or tip of a finger of a person).

An insulation panel 406 of FIG. 4C is triangular in shape and has a tip portion 432, a first side 434, a second side 436, and a third side 438. One exemplary application for the insulation panel 406 is to insulate the intersection between the pipeline and the surface. For example, the insulation panel 406 may be placed on the top of the pipeline with the tip portion 432 positioned at the intersection between the pipeline and the surface and the first side 434 positioned on the pipeline. The second and third sides 436 and 438 of the insulation panel 406 may then be wrapped around the pipeline to insulate the exposed portion of the pipeline extending from the surface.

FIG. 4D is an end view of an insulation panel 408 installed on a component 412 of a pipeline 410. The component 412 of the pipeline 410 is shown for illustrative purposes and may be any component of a pipeline, such as, for example, a shell encasing existing insulation, the junction between two lengths of pipe, or a support structure for the pipeline. As shown, the component 412 of the pipeline 410 is supported by two legs 450 and 452. The insulation panel 408 is shaped and configured to wrap around the component 412 and includes openings or slots 416 and 418 that provide clearance for the legs 450 and 452 supporting the component 412.

FIG. 13 is a top view of an insulation panel 1300 installed on a pipeline 1310 having a bend or non-straight section. As shown, the insulation panel 1300 has a first side 1320, a second side 1322, a third side 1340, and a fourth side 1342. The first side 1320 is positioned on a first portion of the pipeline 1310 on one side of the bend or non-straight section and the second side 1322 is positioned on a second portion of the pipeline on the other side of the bend or non-straight section. The third and fourth sides 1340 and 1342 of the insulation panel 1300 are wrapped around the pipeline 1310 to insulate the bend or non-straight section of the pipeline. The third side 1340 of the insulation panel 1300 is wrapped around the longer outside of the bend or non-straight section and the fourth side 1342 is wrapped around the shorter inside of the bend or non-straight section.

The insulation panel may include one or more vent openings or slots in the cover. For example, FIG. 5 illustrates an insulation panel 500 comprising vent openings 506 in a cover 504 configured to permit air to escape from inside the cover when the insulation panel is compressed, such as when the panel is compressed and packaged for shipment. For example, the insulation panel 500 may be compressed to a relatively thin dimension that permits efficient packaging and transportation. As such, multiple insulation panels may be packaged in the same space that would have been occupied by an uncompressed panel. The insulation panel 500 may also include one or more valves in vent openings 506 or other locations to control airflow into and out of the insulation panel. One or more of the vent openings 506 may also be configured to permit attachment of a vacuum for removing air from the insulation panel 500 and/or a compressor for inflating the insulation panel, e.g., during installation. One or more of the openings 506 may also be used as a port to blow loosefill or “blown-in” fiberglass or spray foam into the cover 504 of the insulation panel 500.

The insulation panel of the present application may be compressed in a variety of ways. For example, a vacuum may be applied to the insulation panel to remove the air within the panel and compress the insulation material. The insulation panel may also be compressed by rolling and/or folding the panel. Further, a platen, roller, or other similar device may be used to compress the insulation panel. Multiple insulation panels may be compressed together, for example, multiple insulation panels may be stacked and then compressed by a platen, roller, or other similar device.

The insulation panel of the present application may be held in a compressed state in a variety of ways. For example, FIGS. 20A and 20B illustrate an insulation panel 2000 in a compressed configuration and an expanded configuration, respectively, according to an embodiment of the present application. As illustrated in FIG. 20A, a compression force C is applied to the insulation panel 2000 and the air within the panel is substantially evacuated. One or more vent openings 2018 in the cover 2004 of the insulation panel 2000 are blocked with a closure device 2020 to prohibit air from entering the insulation panel when the compression force C is removed. The closure device 2004 may be a variety of devices, such as, for example, a lid, cover, plug, tape, valve, or the like. As such, the insulation material 2002 of the insulation panel 2000 remains compressed and is prohibited from expanding by the cover 2004.

As illustrated in FIG. 20B, the closure device 2020 is removed or opened to permit air A to enter the insulation panel 2000. The insulation material 2002 is permitted to expand E within the cover 2004 and recover substantially back to its original or uncompressed density and thickness. After the insulation material 2002 recovers, the closure device 2020 may be applied or closed to prohibit water or other substances from getting in the insulation panel 2000 through the one or more vent openings 2018.

The recovery rate of the insulation material (i.e., period of time for the insulation material to return substantially back to its original density and thickness) after compression may be controlled in a variety of ways. For example, the insulation panel may comprise one or more integral member for controlled recovery of the insulation material. The integral member controls the rate of expansion of the insulation material such that, for example, the insulation material does not expand too quickly or too slowly. The integral member may include, for example, an opening or hole in the cover of the insulation panel (e.g., a reduced diameter orifice), a closure device, a valve, etc.

For example, the one or more vent openings 2018 in the cover 2004 of the insulation panel 2000 may be sized and configured to restrict the amount of air flow into the insulation panel. As such, the one or more vent openings 2018 control the rate of expansion of the insulation material 2002 by controlling the amount of air flow into the insulation panel 2000. In this regard, the one or more vent openings 2018 act as an integral member for controlled recovery of the insulation material 2002. Further, one or more valves may be used to control the amount of air flow into the insulation panel 2000 through the one or more vent openings 2018. As such, the expansion of the insulation material 2002 may be controlled by opening and closing the one or more valves to restrict the amount of air flow into the insulation panel 2000. In this regard, the one or more valves act as an integral member for controlled recovery of the insulation material 2002. Further, a compressor may be used to inflate the insulation panel and increase the rate of expansion of the insulation material.

The recovery rate of the insulation material may also vary based on the type, density, and/or thickness of the insulation material. For example, in one embodiment, the insulation material comprises a 12 inch thick piece of TRS-30 fiberglass insulation having a density of about 1.76 lb/cu ft. When the fiberglass insulation is compressed to about 6 inches thick, it takes from about 6 to about 12 hours for the fiberglass insulation to expand substantially back to its original thickness and density. The ability of the insulation material to recover substantially back to its original thickness and density permits the insulation material to substantially return to its original thermal resistance.

The insulation panel of the present application may also be secured when compressed such that it is held in a compressed configuration. The compressed insulation panel may be secured in a variety of ways, such as, for example, with bands, ropes, chains, straps, or other flexible members or with clips, plates, bolts, loops, hooks, or other fasteners. Further, the compressed insulation panel may be placed in a container, box, bag, or other like structure that prohibits the insulation panel from expanding. In one embodiment, the insulation panel is compressed and rolled and then banded such that the insulation material is prohibited from expanding (See FIG. 21A). Prior to installation, the bands are broken and the insulation panel is permitted to expand back to its uncompressed configuration. Exemplary embodiments of methods for installing the insulation panels, including the method illustrated by FIGS. 21A-21D, are described in more detail below.

The insulation panels of the present application may also include features that discourage tampering, theft, or sabotage of the panel. For example, one or more of the fasteners used to secure the insulation panel to the pipeline may be tamper proof. One exemplary tamper proof fastener includes a bolt with a unique head requiring a special tool to remove the fastener (e.g., a bolt with a pentagonal head having a pin in the middle). The cover of the insulation panel may also be made of tear or cut resistant material to discourage cutting the panel around one more of the openings used to secure the panel to the pipeline. Further, a fence or cage may be placed or wrapped around the insulated panels of the pipeline in populated areas to discourage access to the pipeline.

The insulation panels may be connected to one or more adjacent insulation panels on the pipeline to form a long continuous insulated pipeline or other structure. The adjacent insulation panels may also be configured to prohibit insulation gaps between the panels when installed on a pipeline. For example, FIG. 9 illustrates a first insulation panel 902 and a second insulation panel 904 installed on a pipeline 906. The insulation panels 902 and 904 are wrapped around the circumference or outer surface of the pipeline 906 and about a longitudinal axis 908 of the pipeline. As shown, a connector 960 may be used to connect the insulation panels 902 and 904 together, e.g., fastening the intersecting sides of the panels together. The connector 960 may be a variety of devices capable of connecting the insulation panels 902 and 904 together. For example, the connector 960 may include one or more fasteners (e.g., a bolt, clip, pin, Velcro, hook and loop, hog ring, or the like) or an elongated flexible member, such as a rope, cord, chain, band, or the like. The connector 960 may also be a piece of flexible or non-flexible material, such as a plate, that is attached to both the first and second insulation panels 902 and 904 to secure the panels together.

Adjacent insulation panels may also be shingled to prohibit insulation gaps between the panels when installed on a pipeline. For example, FIG. 10 illustrates a first insulation panel 1022 and a second insulation panel 1024 installed on the pipeline 906. The insulation panels 1022 and 1024 are wrapped around the circumference or outer surface of the pipeline 906 and about the longitudinal axis 908 of the pipeline. As shown, a portion 1070 of the second insulation panel 1024 overlaps the intersecting side of the first insulation panel 1022. This overlap of the adjacent insulation panels 1022 and 1024 prohibits any insulation gap between the panels. As described above, a connector may be used to connect the adjacent insulation panels 1022 and 1024 together, e.g., wrapping an elongated flexible member, such as a rope, cord, chain, or the like, around the overlap portion.

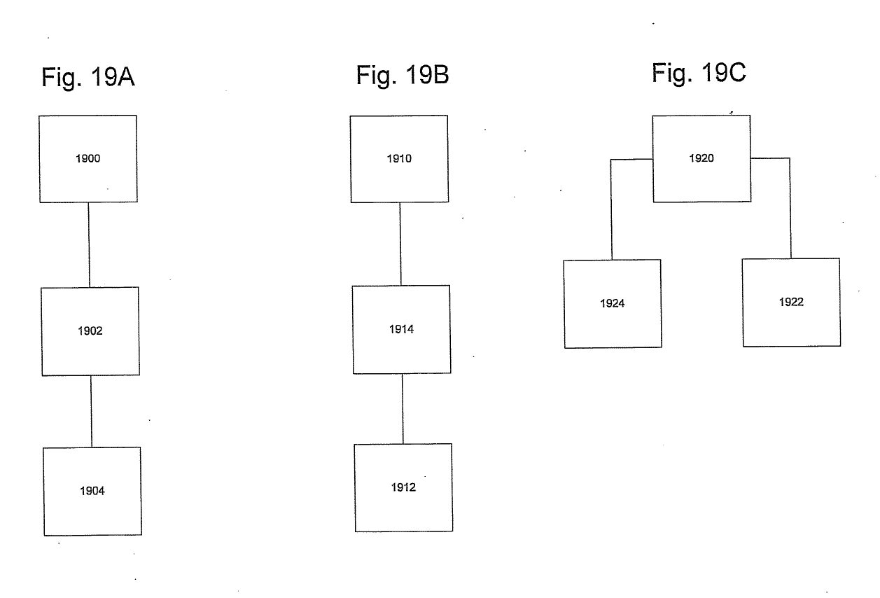

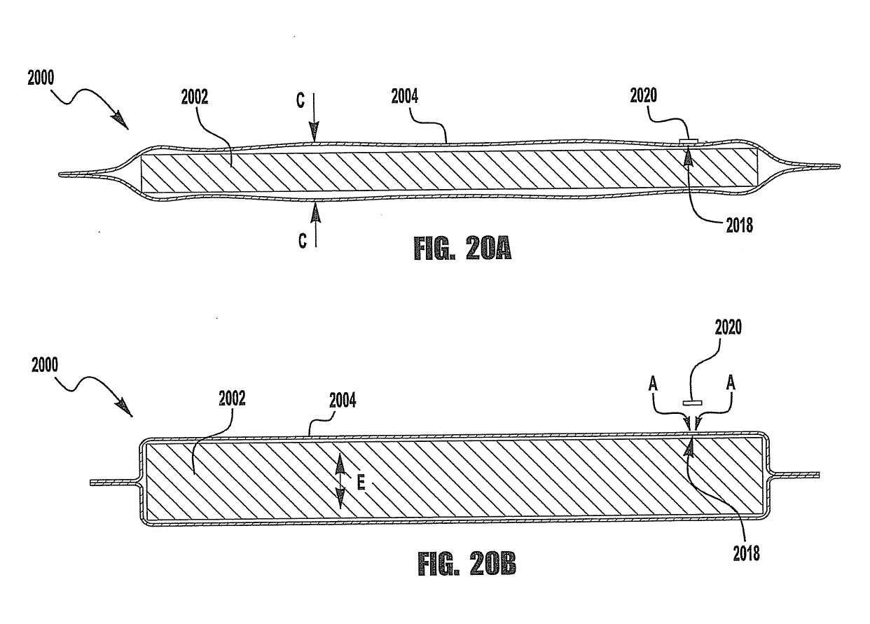

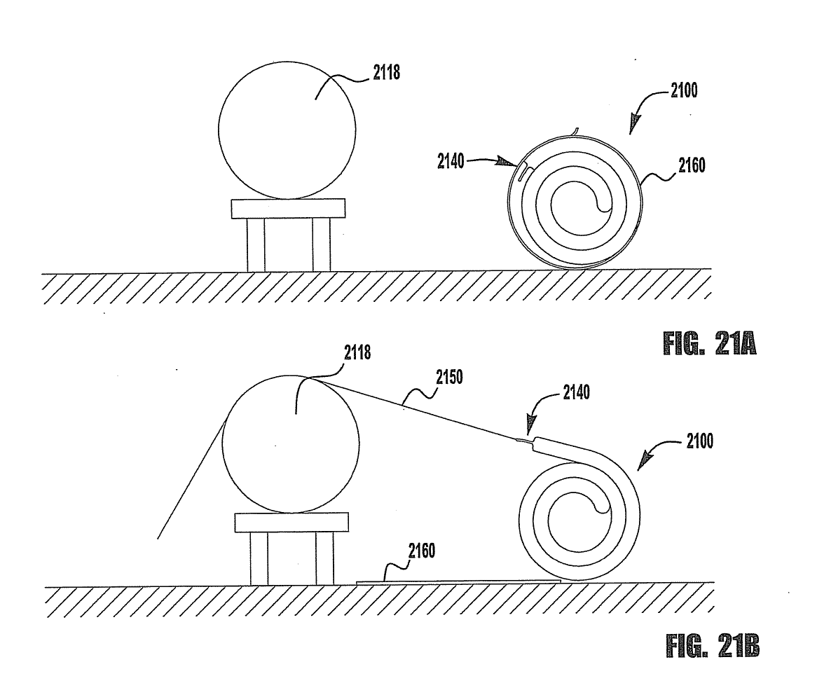

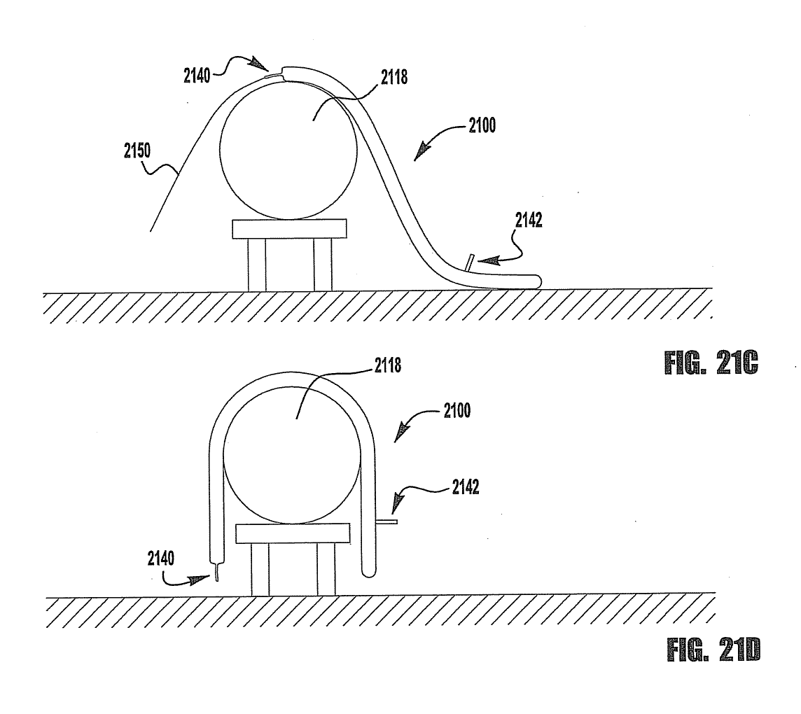

FIGS. 19A-19C illustrate exemplary methods of installing one or more insulation panels of the present application on a pipeline or other structure. In all six methods, the insulation panel may optionally be compressed and prepared for shipment to the pipeline or other structure. In the compressed configuration, the insulation panel takes up less space during shipment and permits more insulation panels to be shipped and delivered at one time. As described herein, the insulation panel may be compressed in a variety of ways, including with a vacuum, platen, roller, or other like device. Further, the insulation panel may be rolled, folded, stacked, or otherwise arranged for shipment. The insulation panel also includes one or more vent openings in the cover to permit air to escape from inside the panel when the panel is compressed.

The insulation panel may be maintained in a compressed state in a wide variety of different ways. In one exemplary embodiment, the insulation panel is compressed and the air within the panel is substantially evacuated. The vent openings in the cover are blocked with a closure device to prohibit air from entering the insulation panel when the compression force is removed. The closure device may be a variety of devices described herein, such as, for example, a lid, cover, plug, tape, valve, or the like. As such, the insulation material remains compressed and is prohibited from expanding by the cover. In another exemplary embodiment, the insulation panel is compressed and then secured in the compressed configuration with a securing device. The securing device may be a variety of devices described herein, such as, for example, bands, ropes, chains, straps, or other flexible members or clips, plates, bolts, loops, hooks, or other fasteners. Further, the securing device may be a container, box, bag, or other like structure that prohibits the insulation panel from expanding.

The ability of the insulation material of the insulation panel to recover substantially back to its original thickness and density after compression permits the insulation material to have a substantially similar thermal resistance before compression and after the insulation material has been compressed and allowed to expand. In the method illustrated by FIG. 19A, the insulation material is compressed 1900 and supplied to an installation site. At the installation site, the insulation material is permitted to expand 1902 within the cover of the insulation panel and recover substantially back to its original or uncompressed density and thickness before it is installed on the pipeline or other structure. For example, a closure device may be removed or opened (see FIGS. 20A and 20B) prior to installation of the insulation panel on the pipeline or other structure. Or, a securing device (see FIGS. 21A and 21B) may be removed prior to installation of the insulation panel on the pipeline or other structure. Once the insulation material expands or recovers, the insulation panel may be installed 1904 on the pipeline or other structure by any method described herein. For example, the insulation panel may be wrapped around a pipeline and then secured to the pipeline.

In the method illustrated in FIG. 19B, the insulation material is permitted to expand and recover after installation of the insulation panel on the pipeline or other structure. The insulation panel is compressed 1910 and delivered to the site of the pipeline or other structure. Before allowing the panel to expand, the insulation panel is installed 1914 on the pipeline or other structure by any method described herein. For example, the insulation panel may be wrapped around a pipeline and then secured to the pipeline. Once the insulation panel is installed, the insulation panel is allowed to expand 1912. For example, a closure device may be removed or opened (see FIGS. 20A and 20B) to permit air to enter the insulation panel. As such, the insulation material is permitted to expand within the cover of the insulation panel and recover substantially back to its original or uncompressed density and thickness. Or, once the insulation panel is installed, a securing device may be removed such that the insulation material is permitted to expand within the cover of the insulation panel and recover substantially back to its original or uncompressed density and thickness. For example, in one embodiment, flexible members wrapped around the width or length of the insulation panel and holding the insulation material in a compressed configuration are cut or otherwise removed after the insulation panel is installed.

In the method illustrated in FIG. 19B, the installation of the insulation panel does not prohibit the insulation material from recovering after the panel is installed. For example, the cover of the insulation panel is not secured to the pipeline or other structure such that it prohibits the insulation material from recovering. As such, the insulation material is permitted to expand substantially back to its original thickness and density after installation.

In the method illustrated in FIG. 19C, the insulation panel is compressed 1920 and delivered to an installation site. The insulation panel is allowed to expand 1922 during installation 1924 of the insulation panel on the pipeline or other structure. As such, the insulation material is permitted to expand within the cover of the insulation panel as the panel is being installed on the pipeline or other structure. For example, in one embodiment, the insulation panel is wrapped around a pipeline and then a closure device is removed or opened prior to the panel being secured to the pipeline. The insulation material may be permitted to expand substantially back to its original thickness and density before the panel is secured to the pipeline. In another embodiment, a closure device is removed or opened prior to wrapping the insulation panel around a pipeline. The insulation material expands within the cover as the insulation panel is wrapped around the pipeline. The insulation material may be permitted to expand substantially back to its original thickness and density before the panel is secured to the pipeline.

Still referring to FIG. 19C, in another exemplary embodiment, a securing device is removed prior to or during installation of the insulation panel on the pipeline or other structure. As such, the insulation material is permitted to expand within the cover of the insulation panel as the panel is being installed on the pipeline or other structure. For example, in one embodiment, the insulation panel is wrapped around a pipeline and then a securing device is removed prior to the panel being secured to the pipeline. For example, one or more flexible members holding the insulation material in the compressed configuration may be cut or otherwise removed after the insulation panel is wrapped around the pipeline. The insulation material may be permitted to expand substantially back to its original thickness and density before the panel is secured to the pipeline. In another embodiment, a securing device is removed prior to wrapping the insulation panel around a pipeline. For example, one or more flexible members holding the insulation panel in a compressed configuration may be cut or otherwise removed prior to wrapping the insulation panel around the pipeline. The insulation material expands within the cover as the insulation panel is wrapped around the pipeline. The insulation material may be permitted to expand substantially back to its original thickness and density before the panel is secured to the pipeline.

In regard to the method illustrated in FIG. 19C, it should be noted that if the insulation panel is secured to the pipeline or other structure prior to the insulation material expanding substantially back to its original thickness and density, the panel is preferably secured such that it does not prohibit the insulation material from recovering. For example, the cover of the insulation panel is preferably not secured to the pipeline or other structure such that it prohibits the insulation material from recovering. As such, the insulation material is permitted to expand substantially back to its original thickness and density after the panel is secured to the pipeline or other structure.

Any of the methods illustrated in FIGS. 19A-19C may include one or more steps of controlling the recovery rate of the insulation material. For example, the insulation panel may include a valve configured to control the amount of air flow into the insulation panel through the one or more vent openings. As such, the expansion of the insulation material may be controlled by opening and closing the valve to restrict the amount of air flow into the insulation panel. Further, a compressor may be used to inflate the insulation panel and increase the rate of expansion of the insulation material.

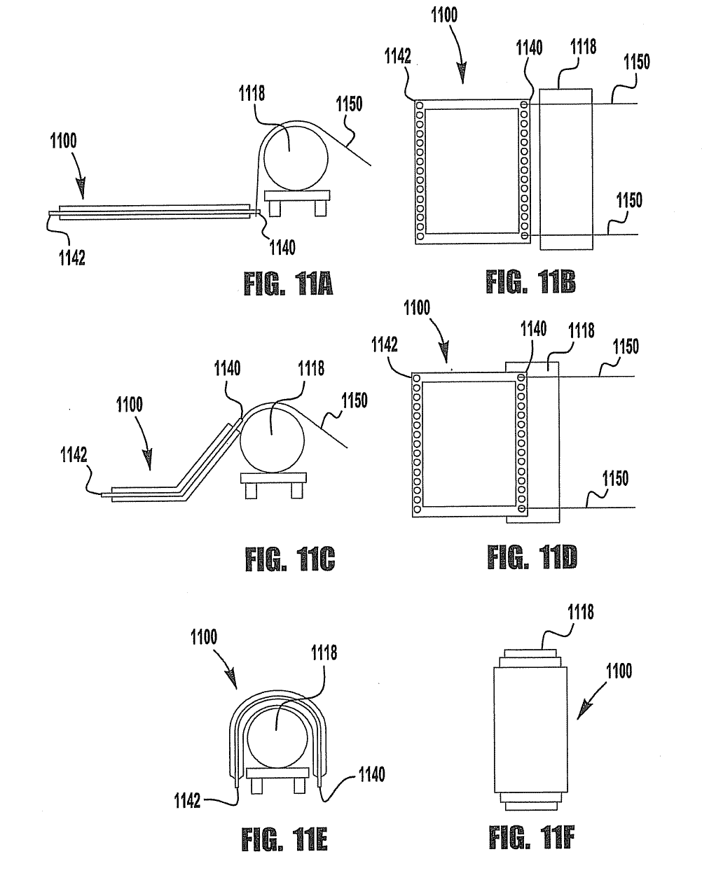

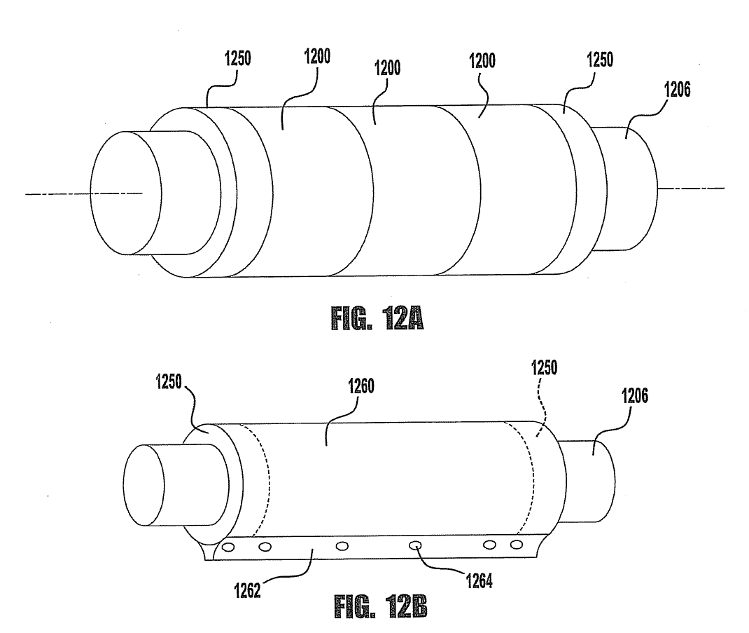

FIGS. 11A-11F and 21A-21D illustrate exemplary methods of installing one or more insulation panels on a pipeline. It should be noted that these methods may used with any of the methods described above and illustrated in FIGS. 19A-19C. In this regard, the insulation material of the insulation panel may expand substantially back to its original thickness and density prior to, during, or after the insulation panel is installed on the pipeline.

As illustrated in FIGS. 11A (end view) and 11B (top view), once the insulation panel 1100 is delivered to the installation site, the panel is positioned on one side of the pipeline 1118. The insulation panel 1100 may be unrolled, unfolded, unstacked, or the like when it is positioned on one side of the pipeline. One or more elongated flexible members 1150 are removably attached to a first end 1140 of the insulation panel 1100. The one or more elongated flexible members 1150 are tossed over the top of the pipeline 1118 to the other side of the pipeline.

The insulation panels of the present application are generally of a size and weight that they can be installed on the pipeline or similar structure by two to four people. As illustrated in FIGS. 11C (end view) and 11D (top view), the one or more elongated flexible members 1150 attached to the first end 1140 of the insulation panel 1100 are used to pull the panel over the top of the pipeline 1118. As illustrated in FIGS. 11E (end view) and 11F (top view), the insulation panel 1100 is draped over the top of the pipeline 1118 with the first and second ends 1140 and 1142 of the panel hanging downward and the inner surface of the panel contacting the outer surface of the pipeline. The insulation panel 1100 is then adjusted and positioned relative to the pipeline 1118, pipeline component, or any adjacent insulation panel. The one or more elongated flexible members 1150 are removed from the first end 1140 of the insulation panel 1100.

The insulation panel 1100 is positioned such that the panel may be secured to the pipeline 1118, pipeline component, or adjacent insulation panel by any means, such as any means disclosed in the present application. For example, the two hanging ends or sides 1140 and 1142 of the insulation panel 1100 may be positioned such that they can be fastened together. The insulation panel 1100 is fastened or secured to the pipeline 1118, pipeline component, or adjacent insulation panel by any means, such as any means disclosed in the present application. For example, one or more elongated flexible members may be used to fasten the hanging ends or sides 1140 and 1142 of the panel 1100 together. One or more elongated flexible members may also be used to secure the insulation panel 1100 around the outer surface of the pipeline 1118.

A second insulation panel may be installed on the pipeline 1118 adjacent to the first insulation panel 1100 by repeating the steps outlined above. The second insulation panel may be positioned relative to the first insulation panel 1100. For example, the second insulation panel may be positioned to butt up against or overlap the first insulation panel 1100. The second insulation panel may be secured to the pipeline 1118, pipeline component, or first insulation panel 1100 by any means disclosed in the present application.

As illustrated in FIG. 21A, the insulation panel 2100 is delivered to the installation site and positioned on one side of the pipeline 2118. The insulation panel 2100 may be secured in a rolled configuration with a flexible securing member 2140 when it is positioned on one side of the pipeline 2118. As illustrated in FIG. 21B, the flexible securing member 2140 is cut or otherwise removed and one or more elongated flexible members 2150 are removably attached to a first fastening portion 2140 located on an outside of the rolled insulation panel 2100. The one or more elongated flexible members 2150 are tossed over the top of the pipeline 2118 to the other side of the pipeline.

As illustrated in FIG. 21C, the one or more elongated flexible members 2150 attached to the first fastening portion 2140 of the insulation panel 2100 are used to pull the panel over the top of the pipeline 2118. The insulation panel 2100 may be unrolled as it is pulled over the top of the pipeline 2118. However, in other embodiments, the insulation panel 2100 is unrolled before it is pulled over the top of the pipeline 2118. As illustrated in FIG. 21D, the insulation panel 2100 is draped over the top of the pipeline 2118 with the ends of the panel hanging downward and the inner surface of the panel contacting the outer surface of the pipeline. The insulation panel 2100 is then adjusted and positioned relative to the pipeline 2118, pipeline component, or any adjacent insulation panel. The one or more elongated flexible members 2150 are removed from the first fastening portion 2140 of the insulation panel 2100.

The insulation panel 2100 is positioned such that panel may be secured to the pipeline 2118, pipeline component, or adjacent insulation panel by any means disclosed in the present application. For example, as described above and illustrated in FIGS. 16A and 16B, the insulation panel 2100 may be configured such that the ends of the panel overlap when installed about the pipeline 2118. As such, a connector may be used to pull the first fastening portion 2140 toward a second fastening portion 2142 to tighten the insulation panel 2100 against the pipeline 2118. The connector may be one or more fasteners (e.g., a bolt, clip, pin, hook and loop, hog ring, or the like) or an elongated flexible member, such as a rope, cord, band, chain, or the like.

A second insulation panel may be installed on the pipeline 2118 adjacent to the first insulation panel 2100 by repeating the steps outlined above. The second insulation panel may be positioned relative to the first insulation panel 2100. For example, the second insulation panel may be positioned to butt up against or overlap the first insulation panel 2100. The second insulation panel may be secured to the pipeline 2118, pipeline component, or first insulation panel 2100 by any means disclosed in the present application. In one embodiment, a section of the pipeline 2118 between supporting structures is about 48 feet long and the insulation panel is about 6 feet wide. As such, six insulation blankets 2100 are installed end to end to insulate the section of the pipeline 2118.

It should be noted that the insulation panel of the present application is configured such that it may be installed on a pipeline or other structure according to the methods described above year round. As described above, the cover and insulation material of the insulation panel may be flexible at low temperatures such that the panel is flexible when installed during the winter months.

In some embodiments, the insulation panel of the present application may not be able to be pulled over the top of the pipeline or other structure. For example, a pipeline may extend over water, such as a lake or river, or the insulation panel may be of a size and weight that prohibits manually pulling the insulation panel over the pipeline or other structure. In these and other embodiments, a machine, such as a cherry picker, forklift, helicopter, or the like, may be used to place the insulation panel on or about the pipeline or other structure.

As mentioned above, the insulation panel of the present application may be used to insulate a variety of objects, such as tanks, vessels, trailers, or railroad tank cars. In this regard, the embodiments disclosed herein may be applied to these and other objects with the pipeline or other component replaced by the tank, vessel, etc.

FIGS. 12A and 12B illustrate a plurality of insulation panels of the present application installed on a pipeline. As illustrated in FIG. 12A, three insulation panels 1200 are installed on a pipeline 1206 with a seal ring 1250 at each end. As illustrated in FIG. 12B, the plurality of insulation panels 1200 are covered by an overwrap 1260 that provides long term weather and UV protection to the panels. As such, the overwrap 1260 covers the seams between the insulation panels 1200. With the seams between the panels 1200 covered by the overwrap 1260, the potential of water getting in and damaging the insulation material of the panels is reduced.

In one embodiment, the insulation panels 1200 include insulation material encased within a cover or jacket. The cover of the insulation panels 1200 may be lightweight and configured to protect the insulation material during shipment and installation. The cover may also be configured such that the panel 1200 may be vacuum sealed. As such, the insulation panels 1200 may be compressed for shipping by evacuating the air within the panel, as described above. In another embodiment, the insulation panels 1200 do not include a jacket or cover. Instead, only the insulation material of the panel 1200 is installed on the pipeline 1206.

The seal rings 1250 positioned at each end of the insulation panels 1200 installed on the pipeline 1206 may be made of a variety of materials. For example, in one embodiment, the seal ring 1250 is made of an insulating foam, such as polystyrene or polyurethane. In another embodiment, the sealing ring 1250 is made of a fiberglass composite. The seal ring 1250 may also include one or more gasketed sealing surfaces to seal the ring relative to the pipeline 1206, panels 1200, and/or overwrap 1260.

As illustrated in FIG. 12B, once the insulation panels 1200 and the sealing rings 1250 are installed on the pipeline 1206, the overwrap 1260 is draped over the panels to cover the panels and the sealing rings. Further, the overwrap 1260 may be sealed at either end against the pipeline 1206 and/or a pipeline support structure. The overwrap 1260 may also be sealed at either end against the sealing rings 1250. The overwrap 1260 may be fastened to the pipeline 1206 and/or insulation panels 1200 by any of the various methods described above. For example, as illustrated in FIG. 12B, the sides 1262 of the overwrap 1260 are secured together towards the bottom of the pipeline 1206. The sides 1262 of the overwrap 1260 comprise openings 1264, such as grommets, that permit the sides of the overwrap to be fastened together, such as with an elongated flexible member, a fastener, or the like. Examples of an elongated flexible member include, but are not limited to, a rope, chain, cord, band, or the like. In some embodiments, the sealing rings 1250 are not used and the overwrap 1260 covers only the insulation panels 1200, including the ends of the insulation panels.

FIGS. 18A and 18B illustrate an overwrap 1860 according to another embodiment of the present application. FIG. 18A illustrates four insulation panels 1800 installed on a pipeline 1806. FIG. 18B illustrates the overwrap 1860 covering the four insulation panels 1800. The overwrap 1860 is secured to the pipeline 1806 at either end of the insulation panels 1800. Each end 1862 and 1864 of the overwrap 1860 comprises openings that permit the overwrap to be cinched or otherwise secured like a drawstring around the outer surface of the pipeline 1806. As shown, an elongated flexible member, such as a rope, chain, cord, band, or the like, is used to cinch the ends 1862 and 1864 of the overwrap 1860 around the outer surface of the pipeline 1806.

The overwrap 1260 and 1860 may be made of the various flexible cover materials described above to provide long term weather and UV protection to the insulation panels. The material of the overwrap 1260 and 1860 may be strong, tough, durable, lightweight, flexible (even at low temperatures), weather resistant, and/or water resistant. The material of the overwrap 1260 and 1860 may also be UV or sunlight resistant, wind resistant, tear/puncture resistant, chemical resistant, mildew resistant, insect/rodent resistant, and/or biodegradable. The overwrap 1260 and 1860 may also be repaired if punctured, torn, or otherwise damaged, such as with a heat sealable patch.

A fabric may be used for the overwrap 1260 and 1860. The fabric may be a coated fabric, such as the geo-membrane material used as pond or pit liners. The fabric material may be made, for example, of a medium or high density polyethylene, various polyesters, reinforced polyethylene, ethylene propylene diene monomer (EPDM), polyvinyl chloride (PVC), and/or polypropylene material. The fabric may be knitted, woven or nonwoven. The material may be a variety of weights, such as from about 5 to about 40 oz/sq yd.

In one embodiment, the overwrap 1260 and 1860 is made from a geo-membrane material known as 8124 XRFR, manufactured by Seaman Corporation. This material may be supplied in sheets, or rolls, with a nominal weight of about 24 oz/sq yd. This material is capable of withstanding inclement weather conditions and is flexible at temperatures as low as −67 degrees F. This material is also water resistant, weather resistant, durable, tough, UV or sunlight resistant, and tear/puncture resistant. This material may also be used as a cover material for one or more insulation panels.

While the present invention has been illustrated by the description of embodiments thereof, and while the embodiments have been described in considerable detail, it is not the intention of the applicants to restrict or in any way limit the scope of the invention to such details. Additional advantages and modifications will readily appear to those skilled in the art. For example, where components are releasably or removably connected or attached together, any type of releasable connection may be suitable including for example, locking connections, fastened connections, tongue and groove connections, etc. Still further, component geometries, shapes, and dimensions can be modified without changing the overall role or function of the components. Therefore, the inventive concept, in its broader aspects, is not limited to the specific details, the representative apparatus, and illustrative examples shown and described. Accordingly, departures may be made from such details without departing from the spirit or scope of the applicant's general inventive concept.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

We claim:

1. An insulation panel for insulating a pipeline comprising:
one or more pieces of compressible fiberglass insulation material having an R value per inch of thickness from about 2 to about 10 hr-sq ft-deg F./Btu measured at 75 degrees Fahrenheit, wherein the insulation material is configured to return substantially back to its original thickness and density after being compressed; and
a coated fabric cover encasing the one or more pieces of insulation material, wherein the coated fabric cover has a weight from about 5 to about 40 oz/sq yd, and wherein the coated fabric cover comprises a first fastening portion disposed along a first end of the insulation panel and a second fastening portion disposed between the first end and a second end of the insulation panel; and
wherein the insulation panel is configured such that, when the insulation panel is installed around a pipeline having a diameter from about 24 to about 78 inches, the first end of the insulation panel overlaps the second end of the insulation panel and attachment of the first fastening portion to the second fastening portion secures the coated fabric cover around the pipeline.

2. The insulation panel of claim 1, wherein the overlapping portion of the insulation panel includes a first portion of the compressible fiberglass insulation material overlapping a second portion of the compressible fiberglass insulation material.

3. The insulation panel of claim 1, wherein the second fastening portion is substantially parallel to the first fastening portion.

4. The insulation panel of claim 1, wherein a bottom surface of the insulation panel contacts an outer surface of the pipeline and a top surface of the insulation panel is exposed to the environment, and wherein the second fastening portion is disposed on the top surface of the insulation panel at a distance from about 6 to about 24 inches from the second end of the insulation panel.

5. The insulation panel of claim 1, wherein the first fastening portion comprises a first row of spaced apart openings and the second fastening portion comprises a second row of spaced apart openings, and wherein the first and second rows of spaced apart openings are configured such that attachment of openings of the first row of openings to openings of the second row of openings secures the coated fabric cover around the pipeline.

6. The insulation panel of claim 1, wherein the first fastening portion is attached to the second fastening portion by a connector, and wherein tightening the connector pulls the first fastening portion toward the second fastening portion to tighten the insulation panel against an outer surface of the pipeline.

7. The insulation panel of claim 6, wherein the connector is one or more elongated flexible members routed through one or more first openings in the first fastening portion and one or more second openings in the second fastening portion to attach the fastening portions together.

8. The insulation panel of claim 1, wherein the first fastening portion is configured as a flap extending outward from the first end of the insulation panel and the second fastening portion is configured as a flap attached to the coated fabric cover and extending outward from a top surface of the insulation panel.

9. The insulation panel of claim 8, wherein the first fastening portion and the second fastening portion extend the entire width of the insulation panel.

10. The insulation panel of claim 1, wherein the pipeline comprises an existing insulation system having insulation disposed around a pipe of the pipeline and a hard shell that encases the insulation disposed around the pipe.

11. The insulation panel of claim 1, wherein a top surface of the insulation panel presses against a bottom surface of the insulation panel to form a seal when the insulation panel is installed around the pipeline.

12. The insulation panel of claim 1 further comprising at least one vent in the coated fabric cover that permits air to escape from inside the cover when the insulation panel is compressed.

13. The insulation panel of claim 12, wherein the at least one vent is a hole in the coated fabric cover.

14. The insulation panel of claim 12, wherein the at least one vent comprises a valve configured to control the airflow into and out of the coated fabric cover.

15. The insulation panel of claim 1, wherein the coated fabric cover comprises a geo-membrane material.

16. The insulation panel of claim 15, wherein the geo-membrane material is a polyester fabric having a PVC coating.

17. The insulation panel of claim 16, wherein the geo-membrane material has a nominal weight of about 12 oz/sq yd.

18. The insulation panel of claim 1, wherein a four inch thick piece of the one or more pieces of compressible fiberglass insulation material has an R value from about 16.7 to about 18.2 hr-sq ft-deg F./Btu measured at 75 degrees Fahrenheit.

19. The insulation panel of claim 1, wherein the insulation material comprises two or more stacked layers of compressible fiberglass insulation material, and wherein at least two of the stacked layers have different lengths to facilitate installing the insulation panel around the pipeline.

20. A method of insulating a pipeline comprising:
delivering an insulation panel to the pipeline, the insulation panel comprising:
one or more pieces of compressible fiberglass insulation material having an R value per inch of thickness from about 2 to about 10 hr-sq ft-deg F./Btu measured at 75 degrees Fahrenheit, wherein the insulation material is configured to return substantially back to its original thickness and density after being compressed; and
a coated fabric cover encasing the one or more pieces of insulation material, wherein the coated fabric cover has a weight from about 5 to about 40 oz/sq yd, and wherein the coated fabric cover comprises a first fastening portion disposed along a first end of the insulation panel and a second fastening portion disposed between the first end and a second end of the insulation panel;
attaching one or more elongated flexible members to the first fastening portion;
tossing the one or more elongated flexible members over the top of the pipeline;
using the one or more elongated flexible members to pull the insulation panel over the top of the pipeline such that the insulation panel is draped over the top of the pipeline;
overlapping the first end of the insulation panel with the second end of the insulation panel, and
attaching the first fastening portion to the second fastening portion to secure the coated fabric cover of the insulation panel around the pipeline.

21. The method of claim 20, wherein the overlapping portion of the insulation panel includes a first portion of the compressible fiberglass insulation material overlapping a second portion of the compressible fiberglass insulation material.

22. The method of claim 20, wherein the pipeline has a diameter from about 24 to about 78 inches.

23. The method of claim 20, wherein the pipeline comprises an existing insulation system having insulation disposed around a pipe of the pipeline and a hard shell that encases the insulation disposed around the pipe.

24. The method of claim 20, wherein the first fastening portion is attached to the second fastening portion by a connector, and the method further comprises tightening the connector to pull the first fastening portion toward the second fastening portion to tighten the insulation panel against an outer surface of the pipeline.

25. The method of claim 24, wherein the connector is one or more second elongated flexible members routed through one or more first openings in the first fastening portion and one or more second openings in the second fastening portion to attach the fastening portions together.

26. The method of claim 20, wherein the coated fabric cover of the insulation panel has at least one vent that permits air to escape from inside the cover when the insulation panel is compressed, and the method further comprises compressing the insulation panel and securing the insulation panel in a compressed configuration prior to delivering the insulation panel to the pipeline.

27. The method of claim 26, wherein the air within the cover of the insulation panel is substantially evacuated when the panel is compressed, and wherein the insulation panel is secured in the compressed configuration using a closure device configured to block air from entering the at least one vent.

28. The method of claim 27 further comprising removing the closure device to open the at least one vent and decompress the insulation panel such that the insulation material returns substantially back to its original thickness and density.

29. The method of claim 26, wherein the insulation panel is secured in the compressed configuration with one or more second elongated flexible members.

30. The method of claim 29 further comprising removing the one or more second elongated flexible members to decompress the insulation panel such that the insulation material returns substantially back to its original thickness and density.

31. The method of claim 26 further comprising decompressing the insulation panel prior to attaching the first fastening portion to the second fastening portion to secure the coated fabric cover of the insulation panel around the pipeline.

32. The method of claim 26 further comprising decompressing the insulation panel after attaching the first fastening portion to the second fastening portion to secure the coated fabric cover of the insulation panel around the pipeline.

33. The method of claim 20 further comprising installing a second insulation panel on the pipeline adjacent to the insulation panel.

34. The method of claim 20 further comprising installing an overwrap over the insulation panel and fastening the overwrap to the pipeline.

35. The method of claim 34, wherein the overwrap comprises a geo-membrane material having a nominal weight of about 24 oz/sq yd.

36. The method of claim 20, wherein the coated fabric cover of the insulation panel comprises a geo-membrane material having a polyester fabric and a PVC coating.

37. A pipeline, comprising:
a pipe;
insulation disposed around the pipe;
a hard outer shell that encases the insulation disposed around the pipe; and
a plurality of insulation panels secured around the hard outer shell that encases the insulation disposed around the pipe, wherein at least one of the plurality of insulation panels comprises:
one or more pieces of compressible fiberglass insulation material having an R value per inch of thickness from about 2 to about 10 hr-sq ft-deg F./Btu measured at 75 degrees Fahrenheit, wherein the insulation material is configured to return substantially back to its original thickness and density after being compressed; and
a coated fabric cover encasing the one or more pieces of insulation material, wherein the coated fabric cover has a weight from about 5 to about 40 oz/sq yd, and wherein the coated fabric cover comprises a first fastening portion disposed along a first end of the insulation panel and a second fastening portion disposed between the first end and a second end of the insulation panel; and
wherein attachment of the first fastening portion to the second fastening portion secures the coated fabric cover around the hard outer shell.

38. An insulation panel for adding insulation to a pipeline having an existing insulation system that comprises insulation disposed around a pipe of the pipeline and a hard shell that encases the insulation disposed around the pipe, the insulation panel comprising:
one or more pieces of compressible fiberglass insulation material having an R value per inch of thickness from about 2 to about 10 hr-sq ft-deg F./Btu measured at 75 degrees Fahrenheit, wherein the insulation material is configured to return substantially back to its original thickness and density after being compressed; and
a coated fabric cover encasing the one or more pieces of insulation material, wherein the coated fabric cover has a weight from about 5 to about 40 oz/sq yd, and wherein the coated fabric cover comprises a first fastening portion disposed along a first end of the insulation panel and a second fastening portion disposed between the first end and a second end of the insulation panel; and
wherein the insulation panel is configured such that, when the insulation panel is installed around the hard outer shell of the existing insulation system having a diameter from about 24 to about 78 inches, the first end of the insulation panel overlaps the second end of the insulation panel and attachment of the first fastening portion to the second fastening portion secures the coated fabric cover around the hard outer shell.
